(19) United States
(12) Patent Application Publication
(10) Pub. No.: US 2019/0370551 A1
(43) Pub. Date: Dec. 5, 2019

(54) OBJECT DETECTION AND TRACKING DELAY REDUCTION IN VIDEO ANALYTICS

(71) Applicant: QUALCOMM Incorporated, San Diego, CA (US)

(72) Inventors: Songan MAO, San Diego, CA (US); Ying CHEN, San Diego, CA (US)

(21) Appl. No.: 16/417,377

(22) Filed: May 20, 2019

Related U.S. Application Data
(60) Provisional application No. 62/679,544, filed on Jun. 1, 2018.

(51) Int. Cl. G06K 9/00; G06K 9/03; G06T 7/246; G06T 7/11

(52) U.S. Cl. CPC G06K 9/00711; G06K 9/00771; G06T 2207/30232; G06T 7/246; G06T 7/11; G06K 9/03

(57) ABSTRACT

Techniques are provided for maintaining blob trackers for a video sequence. A blob tracker can be identified for a current video frame. A confidence value can be determined for the blob tracker based on characteristics of the blob tracker. A false positive determination analysis can be selected based on the determined confidence value, and can be performed on the blob tracker. A negative result can be determined for the blob tracker for the current video frame based on the false positive determination analysis, indicating that the blob tracker is not associated with a true positive object in the current video frame. Whether the current video frame is a key frame for the blob tracker can be determined based on the negative result for the blob tracker, and a status of the tracker can be determined based on whether the current video frame is a key frame for the blob tracker.

### CROSS-REFERENCE TO RELATED APPLICATIONS

This application claims the benefit of U.S. Provisional Application No. 62/679,544, filed Jun. 1, 2018, which is hereby incorporated by reference, in its entirety and for all purposes.

### FIELD

The present disclosure generally relates to video analytics, and more specifically to techniques and systems for reducing delay in object detection and tracking in video analytics.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption. In some cases, the video data can also be processed by the devices and systems themselves.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. The system with the video analytics can be on a camera device and/or on a server. In some cases, video analytics can send alerts or alarms for certain events of interest. More advanced video analytics is needed to provide efficient and robust video sequence processing.

### BRIEF SUMMARY

In some examples, techniques and systems are described for reducing delay in object detection and tracking in video analytics. The delay in object detection and tracking can be reduced, without increasing the rate at which false positive objects are detected (referred to herein as “false positive rate”). In some cases, a blob detection component of a video analytics system can use data from one or more video frames to generate or identify blobs for the one or more video frames. A blob represents at least a portion of one or more objects in a video frame (also referred to as a “picture”). Blob detection can utilize background subtraction to determine a background portion of a scene and a foreground portion of scene. Blobs can then be detected based on the foreground portion of the scene. The detected blobs can be provided, for example, for blob processing, object tracking, and other video analytics functions. For example, temporal information of the blobs can be used to identify stable objects or blobs so that a tracking layer can be established.

In order to provide a low complexity video analytics solution for video surveillance, after tracking a detected object for a certain duration of time, the system can determine whether the tracked object is to be output or not. However, there may be a large portion of such objects which are false positive objects. For example, after the blob detection process, false positive blobs may be detected and output to the object tracking system. The false positive blobs may then be output to the video analytics system as false positive objects (e.g., due to a tracker associated with the false positive blob being output to the system, such as being displayed as a tracked object). Examples of false positive objects that may be output as tracked objects can include, but are not limited to, moving foliage due to wind, an umbrella or other objects that are still but move due to external elements such as wind, glass doors, isolated shadows, or other suitable objects.

The techniques and systems described herein provide a false positive removal mechanism that can be applied to remove false positives. False positive removal techniques may be based on bounding box history and correlation, and can avoid, to a large extent, high complexity while removing many false positive objects. However, it may be beneficial to also have some pixel level analysis of the texture of the tracked object to determine whether a tracker (and the tracked object) is a true positive or false positive object. For example, a false positive removal mechanism that does not rely on pixel level analysis of texture may not be able to detect false positive objects that have little motion, and/or may incorrectly detect true positive objects as false positives when the objects have little motion.

It can be challenging to determine whether a detected object is a true positive object or false positive object within a very short duration of time (e.g., less than one second or other duration). A trade-off can be made between the false positive rate and the delay of tracking (confirming) objects. In order to reduce the tracking delay without sacrificing the false positive rate, the techniques and systems described herein can unify false positive removal methods for short history durations (e.g., within 15 to 30 frames, corresponding to 0.5 to 1 second in a 30 frame per second video) and for longer history durations (e.g., 60 or more frames). The techniques and systems can also increase the frequency of the false positive removal function call (e.g., from every 30 frames to every 5 frames, or other suitable detection frame duration). The techniques and systems can also utilize a more strict false positive removal process, as compared to other positive removal processes, to avoid false positive objects.

According to at least one example, a method of maintaining blob trackers for one or more video frames of a video sequence is provided. The method includes identifying a blob tracker for a current video frame of the video sequence. The blob tracker is associated with a blob detected for the current video frame. The blob includes pixels of at least a portion of one or more objects in the current video frame. The method further includes determining a confidence value for the blob tracker based on one or more characteristics of the blob tracker. The method further includes performing a false positive determination analysis on the blob tracker. The false positive determination analysis is selected from a plurality of false positive determination processes based on the determined confidence value. The method further includes determining, based on the false positive determination analysis, a negative result for the blob tracker for the current video frame. The negative result indicates the blob tracker is not determined to be associated with a true positive object in the current video frame. The method further includes determining whether the current video frame is a key frame for the blob tracker in response to determining the negative result for the blob tracker for the current video frame. A key frame occurs at a periodic key frame cycle. The method further includes determining a status of the blob tracker based on whether the current video frame is a key frame for the blob tracker. The status of the blob tracker includes a first type of blob tracker that is maintained for further analysis or a second type of blob tracker that is removed from a plurality of blob trackers maintained for the one or more video frames.

In another example, an apparatus for maintaining blob trackers for one or more video frames of a video sequence is provided that includes a memory configured to store video data and a processor coupled to (e.g., in communication with) the memory. The processor is configured to and can identify a blob tracker for a current video frame of the video sequence. The blob tracker is associated with a blob detected for the current video frame. The blob includes pixels of at least a portion of one or more objects in the current video frame. The processor is further configured to and can determine a confidence value for the blob tracker based on one or more characteristics of the blob tracker. The processor is further configured to and can perform a false positive determination analysis on the blob tracker. The false positive determination analysis is selected from a plurality of false positive determination processes based on the determined confidence value. The processor is further configured to and can determine, based on the false positive determination analysis, a negative result for the blob tracker for the current video frame. The negative result indicates the blob tracker is not determined to be associated with a true positive object in the current video frame. The processor is further configured to and can determine whether the current video frame is a key frame for the blob tracker in response to determining the negative result for the blob tracker for the current video frame. A key frame occurs at a periodic key frame cycle. The processor is further configured to and can determine a status of the blob tracker based on whether the current video frame is a key frame for the blob tracker. The status of the blob tracker includes a first type of blob tracker that is maintained for further analysis or a second type of blob tracker that is removed from a plurality of blob trackers maintained for the one or more video frames.

In another example, a non-transitory computer-readable medium is provided that has stored thereon instructions that, when executed by one or more processors, cause the one or more processor to: identify a blob tracker for a current video frame of the video sequence, wherein the blob tracker is associated with a blob detected for the current video frame, the blob including pixels of at least a portion of one or more objects in the current video frame; determine a confidence value for the blob tracker based on one or more characteristics of the blob tracker; perform a false positive determination analysis on the blob tracker, wherein the false positive determination analysis is selected from a plurality of false positive determination processes based on the determined confidence value; determine, based on the false positive determination analysis, a negative result for the blob tracker for the current video frame, the negative result indicating the blob tracker is not determined to be associated with a true positive object in the current video frame; determine whether the current video frame is a key frame for the blob tracker in response to determining the negative result for the blob tracker for the current video frame, wherein a key frame occurs at a periodic key frame cycle; and determine a status of the blob tracker based on whether the current video frame is a key frame for the blob tracker, the status of the blob tracker including a first type of blob tracker that is maintained for further analysis or a second type of blob tracker that is removed from a plurality of blob trackers maintained for one or more video frames.

In another example, an apparatus for maintaining blob trackers for one or more video frames of a video sequence is provided that includes means for identifying a blob tracker for a current video frame of the video sequence. The blob tracker is associated with a blob detected for the current video frame. The blob includes pixels of at least a portion of one or more objects in the current video frame. The apparatus further includes means for determining a confidence value for the blob tracker based on one or more characteristics of the blob tracker. The apparatus further includes means for performing a false positive determination analysis on the blob tracker. The false positive determination analysis is selected from a plurality of false positive determination processes based on the determined confidence value. The apparatus further includes means for determining, based on the false positive determination analysis, a negative result for the blob tracker for the current video frame. The negative result indicates the blob tracker is not determined to be associated with a true positive object in the current video frame. The apparatus further includes means for determining whether the current video frame is a key frame for the blob tracker in response to determining the negative result for the blob tracker for the current video frame. A key frame occurs at a periodic key frame cycle. The apparatus further includes means for determining a status of the blob tracker based on whether the current video frame is a key frame for the blob tracker. The status of the blob tracker includes a first type of blob tracker that is maintained for further analysis or a second type of blob tracker that is removed from a plurality of blob trackers maintained for the one or more video frames.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is an illustration of a video frame of an environment in which various objects are tracked, in accordance with some examples.

FIG. 2 is an illustration of a video frame of an environment in which various objects are tracked, in accordance with some examples.

FIG. 3 is an illustration of a video frame of an environment in which various objects are tracked, in accordance with some examples.

FIG. 4 is an illustration of a video frame of an environment in which various objects are tracked, in accordance with some examples.

FIG. 5 is an illustration of a video frame of an environment in which various objects are tracked, in accordance with some examples.

FIG. 6A is a flowchart illustrating an example of a first sub-process of a true-false positive detection process, in accordance with some examples.

FIG. 6B is a flowchart illustrating an example of a second sub-process of a true-false positive detection process, in accordance with some examples.

FIG. 7 is a block diagram illustrating an example of a true-false positive analysis system, in accordance with some examples.

FIG. 8 is a diagram illustrating an example of an intersection and union of two bounding boxes, in accordance with some examples.

FIG. 9 is a graph illustrating an example of true-false positive detection results, in accordance with some embodiments.

FIG. 10 is a flowchart illustrating an example of a process of maintaining blob trackers, in accordance with some embodiments.

FIG. 11A and FIG. 11B are illustrations of video frames of an environment in which various objects are tracked, in accordance with some examples.

FIG. 12A and FIG. 12B are illustrations of video frames of an environment in which various objects are tracked, in accordance with some examples.

FIG. 13A and FIG. 13B are illustrations of video frames of an environment in which various objects are tracked, in accordance with some examples.

FIG. 14A and FIG. 14B are illustrations of video frames of an environment in which various objects are tracked, in accordance with some examples.

FIG. 15A and FIG. 15B are illustrations of video frames of an environment in which various objects are tracked, in accordance with some examples.

FIG. 16A and FIG. 16B are illustrations of video frames of an environment in which various objects are tracked, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

As described in more detail herein, a video analytics system can generate and detect foreground blobs that can be used to perform various operations, such as object tracking (also called blob tracking) or some of the other operations described above. A blob tracker (also referred to as an object tracker) can be used to track one or more blobs in a video sequence. In some cases, a tracked blob can be considered as an object. A blob tracker can start to be associated with a blob in one frame, and can continue to be associated with the blob across one or more subsequent frames. False positive blobs may be generated during the blob detection process, and may be output as incorrect objects to the video analytics system after the object/blob tracking process. As described in more detail below, systems and methods are described herein for determining the status of objects (and their blob trackers) as true or false positives for object tracking.

Blob detection can be performed (e.g., by a blob detection system) for one or more video frames to generate or identify blobs for the one or more video frames. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or a blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

Blobs can be tracked (e.g., by an object tracking system) using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

Temporal information of detected blobs can be used to identify stable objects or blobs so that the tracking layer can be established. For example, a cost between the blob trackers and blobs can be calculated, and data association can be performed to associate the trackers and blobs using the calculated costs (e.g., using a cost matrix). The blob trackers can then be updated according to the data association, in which case the updated state and location can be calculated and the tracking of the current frame can be fulfilled.

Blob trackers can have various temporal states, such as a new state for a tracker of a current frame that was not present before the current frame, a lost state for a tracker that is not associated or matched with any foreground blob in the current frame, a dead state for a tracker that fails to associate with any blobs for a certain number of consecutive frames (e.g., 2 or more frames, a threshold duration, or the like), a normal state for a tracker that is to be output as an identified tracker-blob pair to the video analytics system, or other suitable tracker states. Another temporal state that can be maintained for a blob tracker is a duration of the tracker. The duration of a blob tracker includes the number of frames (or other temporal measurement, such as time) the tracker has been associated with one or more blobs.

A blob tracker can be promoted or converted to be a normal tracker when certain conditions are met. A tracker is given a new state when the tracker is created and its duration of being associated with any blobs is 0. The duration of the blob tracker can be monitored, as well as its temporal state (new, lost, hidden, or the like). As long as the current state is not hidden or lost, and as long as the duration is less than a threshold duration T1, the state of the new tracker is kept as a new state. A hidden tracker may refer to a tracker that was previously normal (thus independent), but later merged into another tracker C. In order to enable this hidden tracker to be identified later due to the anticipation that the merged object may be split later, it is still kept as associated with the other tracker C which is containing it.

The threshold duration T1 is a duration that a new blob tracker must be continuously associated with one or more blobs before it is converted to a normal tracker (transitioned to a normal state). The threshold duration can be a number of frames (e.g., at least M frames) or an amount of time. In one illustrative example, a blob tracker can be in a new state for 30 frames (corresponding to one second in systems that operate using 30 frames per second), or any other suitable number of frames or amount of time, before being converted to a normal tracker. If the blob tracker has been continuously associated with blobs for the threshold duration (duration ≥T1), the blob tracker is converted to a normal tracker by being transitioned from a new status to a normal status.

In some examples, objects may intersect or group together, in which case the blob detection system can detect one blob (a merged blob) that contains more than one object of interest (e.g., multiple objects that are being tracked). For example, as a person walks near another person in a scene, the bounding boxes for the two persons can become a merged bounding box (corresponding to a merged blob). The merged bounding box can be tracked with a single blob tracker (referred to as a container tracker), which can include one of the blob trackers that was associated with one of the blobs making up the merged blob, with the other blob(s)′ trackers being referred to as merge-contained trackers. For example, a merge-contained tracker is a tracker (new or normal) that was merged with another tracker when two blobs for the respective trackers are merged, and thus became hidden and carried by the container tracker.

A tracker that is split from an existing tracker is referred to as a split-new tracker. The tracker from which the split-new tracker is split is referred to as a parent tracker or a split-from tracker. In some examples, a split-new tracker can result from the association (or matching or mapping) of multiple blobs to one active tracker. For instance, one active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the state “split-new.” Such a split-new tracker can be referred to as the child tracker of the original tracker its associated blob is mapped to. The corresponding original tracker can be referred to as the parent tracker (or the split-from tracker) of the child tracker. In some examples, a split-new tracker can also result from a merge-contained tracker. As noted above, a merge-contained tracker is a tracker that was merged with another tracker (when two blobs for the respective trackers are merged) and thus became hidden and carried by the container tracker. A merge-contained tracker can be split from the container tracker if the container tracker is active and the container tracker has a mapped blob in the current frame.

Object tracking attempts to detect and track objects and to output metadata about the detected objects. However, a video analytics system may detect false positive blobs and associated objects. For example, blob detection may detect one or more false positive blobs for the false positive objects in a frame. A false positive blob may be output as a tracked object when a blob tracker associated with the false positive blob is converted to a normal status, causing a false positive object to be tracked. A tracker used to track a false positive object (and the corresponding blob(s)) is referred to as a false positive tracker.

False positive objects can include background objects that should not be tracked, including moving foliage due to wind or other external event, an object (e.g., umbrella, flag, balloon, or other object) that is generally static but has some movement due to external elements (e.g., wind, a person brushing the object, or other cause), glass doors, objects detected due to lighting condition changes, isolated shadows, objects detected due to shadows of real objects, and any other types of background objects that may have movement.

False positive objects are common and can have a serious impact on the performance of the video analytics system. Tracking of false positive objects can even cause the system to trigger false alarms. In some cases, false positive objects can be irregular in size and can have an irregular or arbitrary moving direction or velocity magnitude compared to real objects. In some cases, false positive objects can remain still (e.g., objects due to lighting condition changes, such as a shadow from overcast cloud, or other suitable false positive objects).

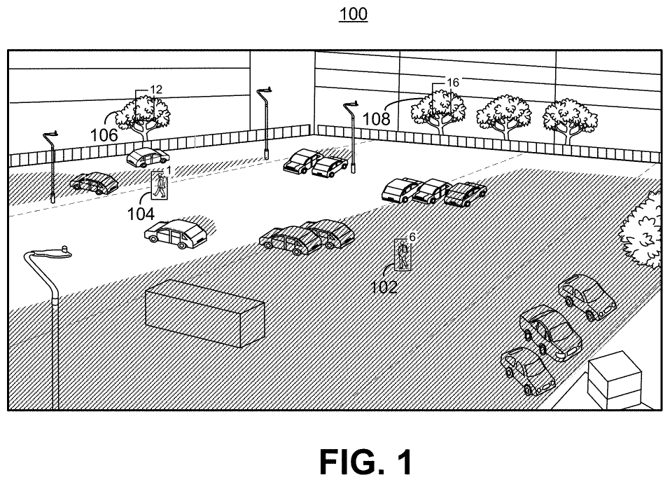

FIG. 1 illustrates an example of a video frame 100 of an environment in which various objects are tracked. The video frame 100 can be generated by a camera system (e.g., one or more IP cameras) monitoring a parking lot. The objects being tracked for the video frame 100 include a person 102, a person 104, a portion of a tree 106, and a portion of a tree 108. The tracked objects are shown with their respective bounding boxes. The person 102 and person 104 are real objects (referred to herein as true positive objects), and are tracked with a blob tracker with tracker ID 6 and a blob tracker with tracker ID 1, respectively. However, the trees 106 and 108 are false positive objects that were detected during blob detection, due to slight movement of the portions of the trees 106 and 108 being tracked. The trackers (with IDs 12 and 16) associated with the blobs detected for the trees 106 and 108 are continuously associated with the trees 106 and 108 for a threshold duration, and thus are converted to a normal status. As a result, the tracker with ID 12 is output for tracking the portion of the tree 106 and the tracker with ID 16 is output for tracking the portion of the tree 108.

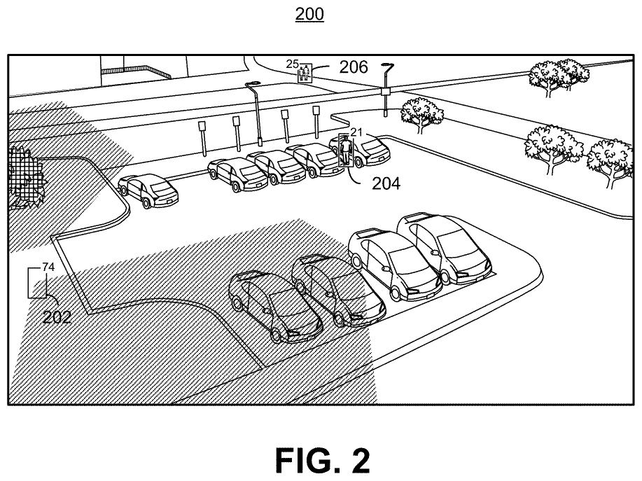

FIG. 2 illustrates another example of a video frame 200 of an environment in which various objects are tracked. The video frame 200 can be generated by a camera system (e.g., one or more IP cameras) monitoring a parking lot. The objects being tracked for the video frame 200 include a portion of a shadow 202, a person 204, a group of persons 206. The tracked objects are shown with their respective bounding boxes. The person 204 and persons 206 are true positive objects that should be tracked. Blob trackers with tracker ID 21 and tracker ID 25 are used to track the person 204 and the persons 206, respectively. The shadow 202 is a false positive object detected during blob detection, due to movement of the portion of the shadow 202 as the sun moves. The tracker (with ID 74) associated with the blob detected for the portion of the shadow 202 is continuously associated with the portion of the shadow 202 for a threshold duration, and is then converted to a normal status. When converted to normal, the tracker with ID 74 is output for tracking the portion of the shadow 202.

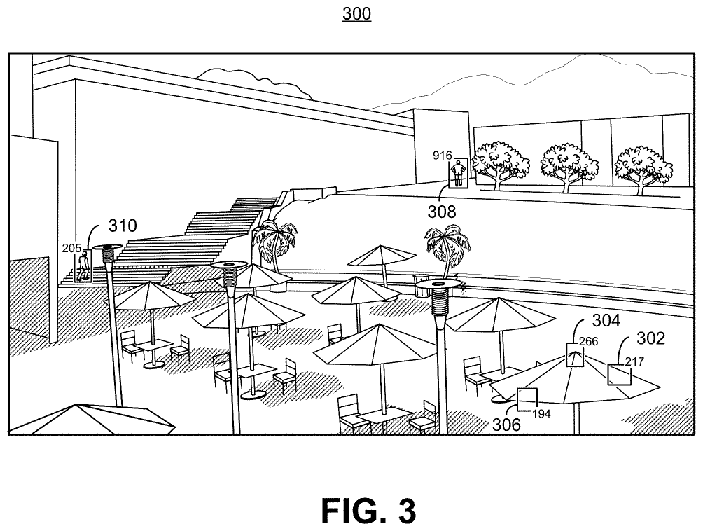

FIG. 3 illustrates another example of a video frame 300 of an environment in which various objects are tracked. The video frame 300 can be generated by a camera system (e.g., one or more IP cameras) monitoring a seating area of a building. The objects being tracked for the video frame 300 include a side portion 302 of an umbrella, a top portion 304 of an umbrella, a front portion 306 of an umbrella, a person 308, and a person 310. The tracked objects are shown with their respective bounding boxes. The person 308 and person 310 are real objects that are of interest for tracking by a video analytics system. Blob trackers with tracker ID 916 and tracker ID 205 are used to track the person 308 and the person 310, respectively. The side portion 302, the top portion 304, and the front portion 306 of the umbrella are false positive objects detected during blob detection, due to movement of the umbrella (e.g., due to wind, due a person moving the umbrella, due to rain, or other cause). The trackers (trackers with ID 217, ID 266, and ID 194) associated with the blobs detected for the side portion 302, the top portion 304, and the front portion 306 of the umbrella are continuously associated with the portions 302, 304, 306 for a threshold duration, causing the trackers to be converted to a normal status. When converted to normal, the trackers with ID 217, ID 266, and ID 194 are output for tracking the side portion 302, the top portion 304, and the front portion 306 of the umbrella, as shown in FIG. 3.

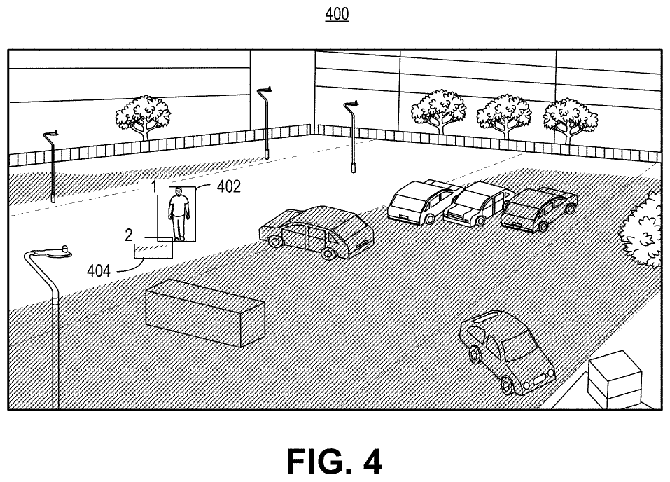

FIG. 4 illustrates an example of a video frame 400 of an environment in which various objects are tracked. The video frame 400 can be generated by a camera system (e.g., one or more IP cameras) monitoring a parking lot. The objects being tracked for the video frame 400 include a person 402 and a shadow 404. The tracked person 402 and shadow 404 are shown with their respective bounding boxes. Person 402 is a real object (referred to herein as true positive objects) and is tracked with a blob tracker with a tracker ID 1. Shadow 404 is also be tracked with a tracker ID 2. However, shadow 404 (of person 402) is a false positive object detected during blob detection due to, for example, a slight movement of the shadow caused corresponding to a slight movement of person 402. The tracker (with ID 2) associated with the blobs detected for shadow 404 may be continuously associated with shadow 404 for a threshold duration, and thus is converted to a normal status. As a result, the tracker with ID 2 is output for tracking shadow 404.

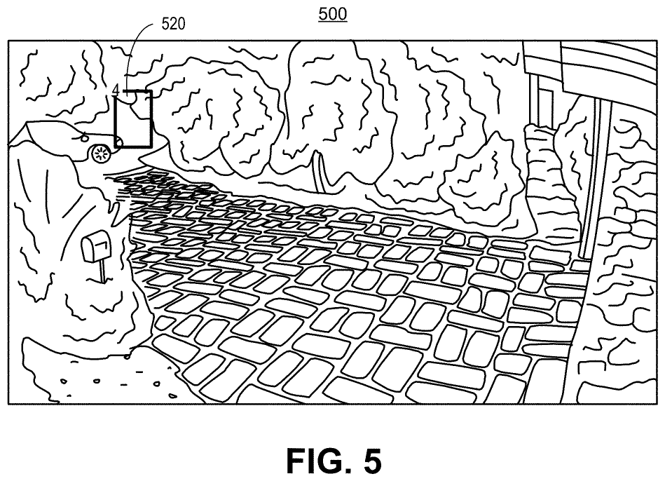

FIG. 5 illustrates another example of a video frame 500 of an environment in which various objects are tracked. The video frame 500 can be generated by a camera system monitoring a front porch of a building. The object being tracked for the video frame 500 include foliage 520 and the portion is enclosed within a bounding box. Foliage 520 is a false positive object detected during blob detection due to, for example, a slight movement of the foliage (e.g., due to wind). The tracker (with ID 4) associated with the one or more blobs detected for foliage 520 may be continuously associated with foliage 520 for a threshold duration, in which case the tracker tracking the one or more blobs will be converted to a normal status. As a result, the tracker with ID 4 is output for tracking foliage 520.

A short duration technique for handling false positive objects can include determining, after a fixed duration of time (e.g., a half second, one second, or other duration), whether a currently tracked object should be considered as a true positive object or a false positive object. For instance, the bounding box history of a tracker (of an object) within the fixed duration can be relied upon to determine if the tracker (and the tracked object) should be considered as true positive or false positive. False positives can be detected and removed based on common characteristics of false positive objects (for which blobs are generated), such as objects that remain still or static and objects that move in an arbitrary direction and/or with irregular direction and speed. Such a technique for detecting false positives determines within a very short duration whether an object is a false positive or not, and is largely based on the movement of the object. For example, a first type of false positive tracker detection can be applied to determine whether an object moves in a relatively static or limited manner. As another example, a second type of false positive tracker detection can be applied to determine if an object has irregular motion or size, which can be based on one or more of object size inconsistency, motion direction inconsistency, and motion magnitude inconsistency. If an inconsistency is detected, irregular motion and/or size is detected for the tracker. If a tracker has irregular motion or size, or is detected as freeze tracker, it will be determined to be a false positive tracker.

If the tracker (and object) is determined to be a true positive, the tracker may be transited to a normal tracker (that the status has been confirmed and will be used for output to the end-to-end video analytics system). If the tracker (and object) is determined to be a false positive, the tracker may be killed and no longer maintained. However, if an object is a true positive object, but has been incorrectly determined to be a false positive and is killed, it will take at least the same fixed duration (e.g., half second, one second, or other duration) after the object tracker has been killed for the object to go to the stage where it will be analyzed again to determine if it should be output as a true positive. Further, when the tracker goes to this stage, the same false positive detection mechanism will be applied to determine whether the object should be removed or not, in which case the object may again be determined to a be a false positive.

In some cases, a long duration technique can be used for handling false positive objects. The long duration technique can be based on a bounding box history of a tracker. For example, a long duration true-false positive detection method can use the bounding box history of a tracker to derive a confidence level for the tracker, which can be used to determine whether the tracker and its associated blob will be a true positive or a false positive. Instead of outputting or killing a tracker immediately, the system can wait until a next cycle of the long duration true-false positive detection to determine whether the tracker should be output or killed. In addition, such a framework may enable a pixel level analysis, such as correlation, to be further used to confirm if an object is a true positive.

In some cases, correlation can be used to detect false positives. Correlation is a strong tool to remove false positive blobs if the pixels within the bounding boxes appear to be moving but are not really moving (e.g., they may have changes in intensity due to the fact of lighting condition change). However, when objects such as foliage move by a small amount (e.g., due to wind or other external factor), a correlation based false positive detection technique might not be able to determine an object generated under such a situation is a true positive or not, since there may be a small correlation in such cases, which will likely not be discriminative enough.

Even further, when big objects are present in the scene, a different type of false positive detection technique may be needed to determine whether the objects are true positives or not. Even when big objects are present and there are ways to determine an object is not a true positive object yet, the complexity associated with the big object is relatively high, since conditions for checking big objects may be much easier to meet (e.g., no duration constraint), and thus a pixel level analysis may be required with a much higher frequency than normal objects.

Various issues can arise with false positive removal mechanisms. For example, the above-described mechanisms typically apply when the duration is a multiple of T, with T being equal to an integer value representing a number of frames (e.g., 30 frames) or an amount of time. Reducing the delay in such systems by reducing the number T will not lead to good results because the false positive removal mechanisms rely on the bounding history of the T frames of the current period, and using a shorter history can lead to inaccuracies in the false positive removal mechanisms.

The short duration false positive removal mechanism described above is different from the long duration false positive removal mechanism. For example, the short duration mechanism applies only for the case when the duration is 30 frames, while the long duration mechanism applies for other durations. It can be beneficial to unify the short and long duration mechanisms to avoid the complication of selecting which method to use (e.g., in the case of a duration within 30 and 60, or other duration). In addition, for other durations less than 30, the short duration mechanism needs to be redesigned and, similarly, for durations that are not multiplications of T, the long duration mechanism also needs to be redesigned.

Overall results are sensitive to the noise of background subtraction results. Due to the sensitivity, only when a detected object has very regular size and motion, it can pass the false positive detection mechanism and be output for display by the end-to-end video analytics system.

For the above reasons, some true positive objects that are present in a short duration in the scene may not be detected at all. Also for the above reasons, there might be objects that will not be tracked for a long time. Such a delay can continue for many seconds (e.g., 5-10 seconds or more).

Systems and methods are described herein that provide a new true-false positive detection mechanism. The true-false positive detection mechanism described herein significantly reduces the delay of object detection and tracking, while also improving the true positive accuracy rate and reducing the false positive error rate. In some examples, an object tracking system can perform the methods described herein. In other examples, one or more other components of a video analytics system can perform the methods described herein. The proposed systems and methods may work independently or jointly to improve object tracking.

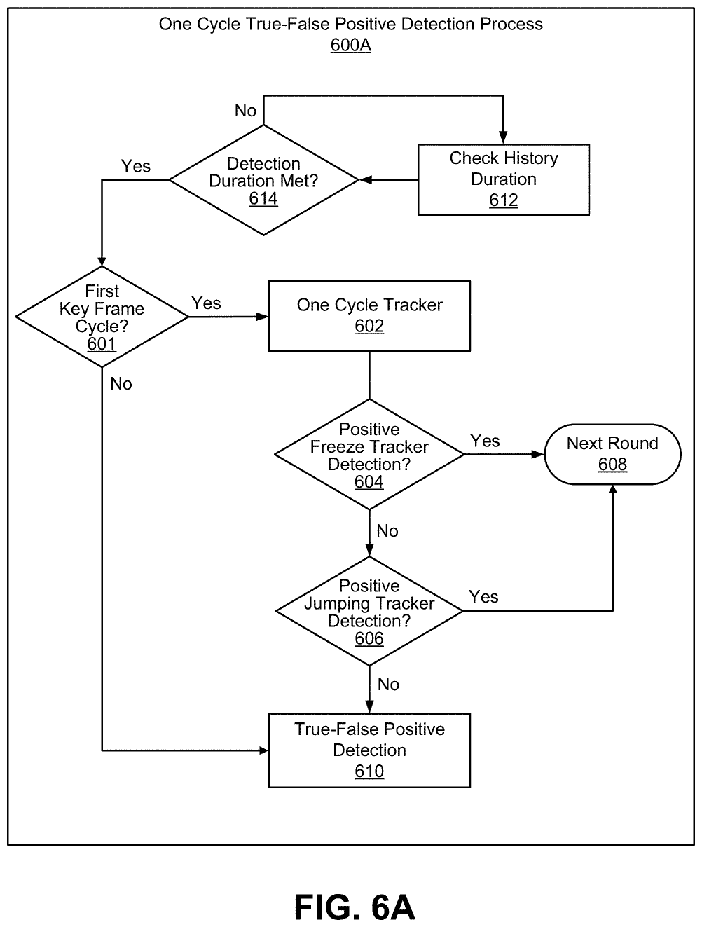

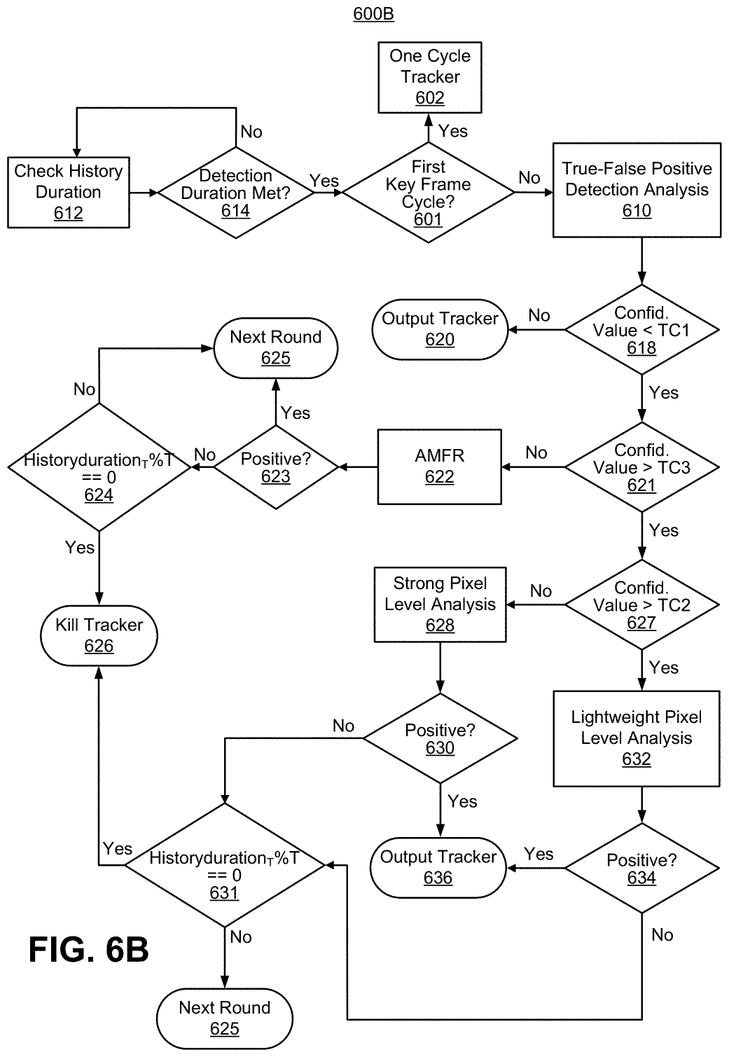

FIG. 6A and FIG. 6B are flow diagrams illustrating a true-false positive detection process (shown as sub-process 600A and sub-process 600B). The true-false positive detection process can be performed on video frames of a video sequence. The video sequence can be captured by an image capture device (e.g., an IP camera, or other suitable image capture device). A video frame that is currently being processed by the process is referred to herein as a current video frame. Trackers can be maintained for the video sequence for tracking one or more blobs (and corresponding objects) in a scene captured in the video sequence. The true-false positive detection process is performed for each blob tracker (also referred to herein as an object tracker) that is associated with a blob (and corresponding object) detected in a current video frame. In some cases, the true-false positive detection process can be performed for blob trackers that are not currently associated with a blob in a current frame, such as a lost tracker.

A history duration (denoted as N) of a blob tracker can be checked at a periodic detection duration (denoted as D) to determine whether to perform the entire true-false positive detection process (including both sub-processes 600A and 600B), or to perform only the true-false positive detection sub-process 600B. For example, the true-false positive detection sub-process 600A can be applied to a blob tracker at each detection duration D only during a first key frame cycle (denoted as T) of the blob tracker. A history duration N of a blob tracker indicates a number of video frames since creation of the blob tracker. For example, when a blob tracker is generated for tracking a detected blob at a current video, the current frame can become frame 1 in the blob tracker's history duration N, the next frame after the current frame can be frame 2 in the blob tracker's history duration, and so on. In some cases, the history duration can be specified by an amount of time.

A key frame cycle T is a period at which each key frame within a history duration N of a blob tracker occurs. A key frame for a blob tracker occurs at every key frame cycle n*T. In one illustrative example used herein, the key frame cycle T can be set to 30 frames (T=30). In such an example, a first key frame will occur at frame 30 (from the initial frame 1 at which the blob tracker was created), a second key frame will occur at frame 60, a third key frame will occur at frame 90, a fourth at frame 120, a fifth at frame 150, and so on. The key frame cycle can be set to any other suitable number of frames, such as 60 frames, 90 frames or the like, depending on application requirements and/or user preferences.

A detection duration D is the duration at which the true-false positive detection process (sub-process 600A and/or sub-process 600B) is performed for a blob tracker. The detection duration D can be set to any value that is less than the key frame cycle T. In one illustrative example, using a value of 30 for the key frame cycle T, the detection duration D can be set to a value of 5, in which case the true-false positive detection process (sub-process 600A and/or sub-process 600B) will be performed for a blob tracker every five frames. The frame at which the true-false positive detection process will be performed is referred to herein as a detection frame, in which case a detection frame occurs every detection duration D.

In some cases, the true-false positive detection process will not be performed for a blob tracker until the history duration N of the blob tracker reaches an initial threshold (denoted as T₀). The initial threshold T₀ defines a minimum number of frames for which a blob tracker must be in existence before the true-false positive detection process will be performed for the blob tracker. The initial threshold number of frames T₀ can be set to any suitable value that is less than the key frame cycle T, such as 5 frames, 10 frames, 15 frames, or the like.

The true-false positive detection sub-process 600A provides an improved framework for a state promotion transition process for detecting whether a current blob tracker is associated with a true positive object or a false positive object. As used herein, a current blob tracker is the tracker currently being analyzed in a current frame of a video sequence, which is the frame that is currently being processed. The sub-process 600A is applied to each detection frame of the current blob tracker during a first key frame cycle (denoted as 1*T) of the blob tracker. For instance, the sub-process 600A can be applied to a blob tracker up until the first key frame of the blob tracker.

At block 612, the sub-process 600A checks the history duration of the current blob tracker. The true-false positive detection process (including sub-processes 600A and 600B) can be periodically performed for each tracker (from the maintained trackers) in an iterative manner based on a detection duration D, as described above. For example, each round of analysis by the true-false positive detection process for a tracker can be periodically invoked when the history duration N of the tracker (since the tracker was created, for example, as a new tracker or a split-new tracker) reaches n*D frames, where n is an integer value. At block 614, the history duration N can be checked for the current tracker for the current frame to determine whether the detection duration D has been met. In one illustrative example, the detection duration D can be set to 5 frames and n can be an integer. In such an example, the true-false positive detection process can be invoked at every integer value n multiple of D, within a first key frame cycle.

In some cases, the history duration N of a tracker (before it is output) can be tracked by a counter starting from 0 when the tracker is created (as a new tracker or a split-new tracker) or when the tracker is newly associated with a blob (e.g., after being lost). The counter can increase by one for every frame. The counter can be denoted as N % D, and can be used to determine when the detection duration n*D has been met (e.g., when N % D is equal to 0, denoted as N % D==0). For example, the sub-process 600A can check the history duration N of a current blob tracker in a current frame at block 612, and can determine at block 614 whether the detection duration D is met. To check the whether the detection duration D is met, the sub-process 600A can determine, at block 612, whether the counter N % D is equal to 0 (N % D==0). If the detection duration is not met for a current tracker (N % D is not equal to 0), the sub-process 600A returns to block 612 to check the history duration for the current tracker at a next frame. Once the detection duration is met, the counter is reset to 0.

If the detection duration is met for a current tracker (N % D is equal to 0), the sub-process 600A continues to block 601. At block 601, the sub-process 600A determines whether the current blob tracker is within its first key frame cycle T. For example, the history duration N of the current tracker can be checked at each detection frame (at each detection duration D of the blob tracker) to determine whether it is the first key frame cycle for the tracker. The current blob tracker has its own unique history duration N, based on when the blob tracker was generated or when the blob tracker was last associated with a blob. The key frame cycle for the current blob tracker is determined based on the history duration N of the blob tracker. Using T=30 as one illustrative example of a key frame cycle, the sub-process 600A is applied to each detection frame of the blob tracker (e.g., N=frame 5, N=frame 10, N=frame 15, etc.) up until N=frame 30. In the event an initial threshold T₀ is used, as described above, the sub-process 600A is applied to each detection frame of the blob tracker between T₀ (e.g., frame 15) and the first key frame (at key frame cycle 1*T).

The current blob tracker is determined to be a one cycle tracker at block 602 if it is determined, at block 601, that the history duration N of the blob tracker is less than or equal to the first key frame (at key frame cycle 1*T) of the blob tracker. If it is determined at block 601 that it is not the first key frame cycle of the current blob tracker, the true-false positive detection process continues to perform the true-false positive detection sub-process 600B (starting with the true-false positive detection analysis at block 610) for the current tracker.

If it is determined at block 601 that it is the first key frame cycle of the current blob tracker, the true-false positive detection sub-process 600B can apply one or more true-false positive detection schemes to detect whether the current blob tracker in its first key frame cycle T is a first type of false positive tracker (referred to as a freeze tracker or frozen tracker) or second type of false positive tracker (referred to as a jumping tracker). For example, at block 604, a freeze tracker detection process is applied to the current blob tracker to determine whether the blob tracker is a freeze tracker. If the current tracker is determined not to be a freeze tracker (a negative result at block 604), a jumping tracker detection process is applied to the current blob tracker to determine whether the blob tracker is a jumping tracker. In some cases, the jumping tracker detection process can be applied before the freeze tracker detection process. The freeze tracker detection and the jumping tracker detection processes can be applied to determine if the tracker (and its object) meet certain characteristics over a duration (e.g., the entire history duration N of the tracker or the most recent detection duration D of the tracker, or other suitable duration), as described in more detail below.

The freeze tracker detection process can be used to determine trackers (and the objects they are tracking) that are relatively frozen or still, which are referred to as freeze trackers or frozen trackers. For example, the freeze tracker detection process can be performed to check if a tracker (and its corresponding object) is too still or static according to the bounding box history of the tracker. In some examples, an alignment threshold and an overlapping ratio between bounding boxes of a tracker can be used to detect frozen objects and frozen trackers. The overlapping ratio can be compared to the alignment threshold to determine if the tracker is still or static in the current frame (relative to a previous frame). The alignment threshold (denoted as F_{Align}) indicates how much of overlap in terms of percentage the history of bounding boxes of a current blob tracker aligns. In some cases, the percentage of overlap can be normalized to 0 and 1. As previously noted, the current blob tracker is the tracker currently being analyzed in the current frame.

In some cases, the alignment threshold F_{Align} can be set to be adaptive to the size of a current bounding box. For example, a small size may corresponds to a smaller alignment threshold. The current bounding box can be the bounding box for the current blob tracker (e.g., determined from the bounding box of the current blob with which the current blob tracker is associated). In some examples, the alignment threshold F_{Align} can be set to a relatively smaller value for a smaller bounding box below a first size threshold, and can be set to a larger value for a larger bounding box above a second size threshold. The first size threshold and the second size threshold can be the same value or a different value. In one illustrative example, the alignment threshold F_{Align} is set as follows:

$${F}_{Align} = \{ \begin{matrix}0.7 , if size < {T}_{A} \\ 0.85 , if size > {T}_{B} \\ 0.8 , otherwise\end{matrix} \qquad Equation ( 2 )$$

where T_{A} is the first size threshold, T_{B} is the second size threshold, and size is the size of the bounding box of the current blob tracker in the current frame. In one illustrative example, T_{A} can be equal to 129 (e.g., corresponding to a 16×8, 8×16, 4×32, 32×4, or other suitable size bounding box) and T_{B} can be equal to 4096 (e.g., corresponding to a 64×64, 32×128, 128×32, or other suitable size bounding box). As shown by equation 2, when the size of the bounding box of the current blob tracker is less than T_{A}, the alignment threshold is set to 0.7. When the size of the current bounding box of the current blob tracker is greater than T_{B}, the alignment threshold is set to 0.85, which is much larger than 0.7. When the “otherwise” condition is met, meaning that the size of the current bounding box is not less than T_{A} and is not more than T_{B}, the alignment threshold is set to 0.8. One of ordinary skill in the art will appreciate that the example in equation 2 is illustrative, and that any other values of the alignment threshold and the size thresholds T_{A} and T_{B} can be used.

In order to measure the level of stillness of the current object (and the corresponding current blob tracker) being tested, an overlapping ratio can be measured. The overlapping ratio includes a ratio of the intersection and union of two bounding boxes of the current blob tracker over two consecutive frames. For example, the two bounding boxes can include the bounding box of the current blob tracker from the current frame and the bounding box of the current blob tracker from the previous frame. In one illustrative example, for a later frame t (e.g., a current frame), the intersection of the two bounding boxes is denoted as Iₜ and the union is denoted as Uₜ. Using such notation, the overlapping ratio for the two bounding boxes is defined as αₜ=Iₜ/Uₜ and therefore is the overlapping ratio for the current blob tracker for frame t.

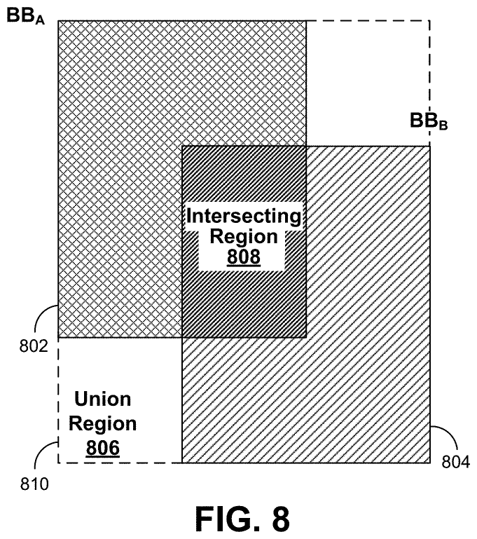

FIG. 8 is a diagram showing an example of an intersection I and union U of two bounding boxes, including bounding box BB_{A} 802 of the blob tracker in the current frame and bounding box BB_{B} 804 of the blob tracker in the previous frame. The intersecting region 808 includes the overlapped region between the bounding box BB_{A} 802 and the bounding box BB_{B} 804.

The union region 806 includes the union of bounding box BB_{A} 802 and bounding box BB_{B} 804. The union of bounding box BB_{A} 802 and bounding box BB_{B} 804 is defined to use the far corners of the two bounding boxes to create a new bounding box 810 (shown as dotted line). More specifically, by representing each bounding box with (x, y, w, h), where (x, y) is the upper-left coordinate of a bounding box, w and h are the width and height of the bounding box, respectively, the union of the bounding boxes would be represented as follows:

Union(BB₁,BB₂)=(min(x₁,x₂),min(y₁,y₂),(max(x₁+w₁−1,x₂+w₂−1)−min(x₁,x₂)),(max(y₁+h₁−1,y₂+h₂−1)−min(y₁,y₂)))

The overlapping ratio αₜ of the current blob tracker can be compared to the alignment threshold F_{Align} to determine if the blob tracker is still (or static) in the current frame. For example, if the overlapping ratio αₜ is larger than the alignment threshold F_{Align} (denoted as αₜ>F_{Align}), the blob tracker is considered to be static in the current frame t (compared to the previous frame). In some examples, if the ratio αₜ is smaller than the alignment threshold F_{Align} (denoted as αₜ≥F_{Align}), the blob tracker is considered to be not static in the current frame t (compared to the previous frame).

In some examples, the number of frames the current blob tracker is considered as being still can be determined. In such examples, the total number of still frames within a duration is firstly used as a condition to determine if a tracker is freeze tracker. The number of frames the current blob tracker is considered as being still can be denoted as s_{T}=Σₜ₌₁^{T}(αₜ>F_{Align}?1:0), where the bounding boxes, blobs, and the containing frames are denoted with the relative timestamp of t, with t being from 1 through N (or D), and where 1 is the time when the tracker was created and N (or D, e.g., measured in frames) is the time when the tracker is being checked to be a frozen tracker. The terminology “?1:0” indicates that a counter is incremented (with a value of 1) when the condition αₜ>F_{Align} is met, and that the counter is not incremented when the condition αₜ>F_{Align} is not met. In one illustrative example, if N is equal to 10 frames (indicating that it has been ten frames since the blob tracker was created or last associated with a blob), and the condition αₜ>F_{Align} is met for eight out of the ten frames, the s_{T} counter will have a value of eight.

The number of frames s_{T} the current blob tracker is considered as being still can then be compared to a threshold number of frames to determine if the current blob tracker is a possible frozen tracker or if the tracker is a good candidate to be detected as a frozen tracker. In one illustrative example, the number of frames s_{T} is compared with the total number of frames N since the tracker was created or the number of frames since the last detection duration D. For example, a threshold Tₚ can be set as a percentage of the total number of frames since the tracker is created (and can be denoted as a threshold number of frames Tₚ). A multiplier m can be set to a relatively large number close to 1 (e.g., 0.7, 0.75, 0.8, 0.85, 0.9, or other suitable value), such that the threshold Tₚ requires a blob tracker to be still in most of the frames since it was created to be considered as a frozen tracker. The threshold Tₚ can be defined as Tp=m*T. If the number of frames s_{T} is larger than the threshold Tₚ (denoted as s_{T}>m*T), the current tracker is considered as a frozen tracker or as a good candidate to be detected as a frozen tracker. In one illustrative example, if m is set to 0.85, to be considered as a frozen tracker, the number of frames (s_{T}) the blob tracker must be detected as being still is 85% of the total number of frames (T) since the blob tracker was created.

In some cases, when a blob tracker does not meet the condition s_{T}>m*T, the blob tracker is determined not to be a good candidate for a freeze tracker, and the whole frozen tracker detection process (e.g., block 604 in FIG. 6A) can terminate for the blob tracker and can identify the blob tracker as not being a freeze tracker. In such cases, the sub-process 600A can determine, at block 604, that the freeze tracker detection process provides a negative result (indicating the blob tracker is not a freeze tracker), and can proceed to the jumping tracker detection process at block 606.

In some cases, when a blob tracker meets the condition s_{T}>m*T, the blob tracker can be detected as a freeze tracker and is a candidate for a false positive tracker. In such cases, the sub-process 600A can determine, at block 604, that a positive result is provided by the freeze tracker detection process, and can transition the tracker to the intermediate status (“next round”) at block 608 so that the tracker can be evaluated using the sub-process 600A and/or sub-process 600B when the next detection duration D is met (at the next round of the true-false positive detection process).

In some examples, when a blob tracker meets the condition s_{T}>m*T, the blob tracker can be considered as a good candidate for a frozen tracker. In such cases, even a blob tracker that is a good candidate for a frozen tracker can be associated with a blob for a real object. For example, the blob tracker (and its associated blob and object) may just move slowly, but consistently, in one direction. Such movement of a blob tracker may lead to the condition s_{T}>m*T being satisfied by the history of the blob tracker. Therefore, in order to prevent a blob tracker with such type of movement from being detected as a frozen tracker, in addition to the stillness inspection between two consecutive frame pairs, the global stillness can be checked to determine whether the current tracker is still. More specifically, several pairs of bounding boxes can be sampled from the beginning and end of the bounding box history for the blob tracker. For example, the sample pairs of bounding boxes can be associated with timestamp pairs of (1+i, N−i), wherein i is equal to 1 through n, and wherein n can be a number (e.g., 4, 5, 6, 7, or any other suitable number). In one illustrative example, if N is equal to 30, and i is equal to 0 through 4 (with n=5), the sampled pairs of bounding boxes for the blob tracker include the bounding box pairs (1, 29), (2, 28), (3, 27), (4, 26), and (5, 25), with the notation (a, b) referring to (frame a, frame b) of the given history duration N. Therefore, n pairs of bounding boxes can be chosen.

An overlapping ratio αᵢ′ is calculated similarly as αₜ, but αᵢ′ is based on the intersection and union of blobs in frame 1+i and frame N−i instead of consecutive frames. The overlapping ratio αᵢ′ can be compared to a threshold Fᵣ to determine global movement of the blob tracker. The threshold Fᵣ can be a fixed value (e.g., 0.75, 0.80, 0.85, or other suitable value). In one illustrative example, if αᵢ′ is smaller than a threshold Fᵣ (denoted as αᵢ′<Fᵣ), the blob tracker is considered to be moving and thus not a frozen tracker. In such an example, the whole freeze tracker detection process (e.g., block 604 in FIG. 6A) can terminate for the blob tracker and can identify the blob tracker as not being a frozen tracker. The sub-process 600A can determine a negative result at block 604 and can proceed to the jumping tracker detection process at block 606.

In some examples, when, for any pair among the n pairs of tracker bounding boxes, the overlapping ratio αᵢ′ is always larger than Fᵣ (indicating the global movement is small due to much overlap), the blob tracker that was considered as a good candidate for a frozen tracker is finally identified as a frozen tracker. Once the blob tracker is detected as a frozen tracker, the sub-process 600A can determine, at block 604, that a negative result is provided by the freeze tracker detection process. The sub-process 600A can then transition the tracker to the intermediate status (“next round”) at block 608 so that the tracker can be evaluated using the true-false positive detection process at the next detection duration D.

The jumping tracker detection process can be used to determine trackers (and the objects they are tracking) with size and/or motion that is too irregular to be associated with an object of interest. For example, the jumping tracker detection process can be performed to check if the current tracker (and its corresponding object) has certain irregular size changes and/or has irregular motion according to the bounding box history of the tracker. For example, jumping trackers may be associated with blobs (representing objects) from irrelevant neighboring blobs or from noisy background objects even when the blobs for the objects are consistently associated with a tracker.

In some examples, to identify whether a blob tracker has an irregular size change over the duration (e.g., the entire history duration N of the tracker, the most recent detection duration D of the tracker, or other suitable duration), the size of the tracker within each frame t can be set to the size of the bounding box of the blob associated with the blob tracker in the frame t. The size can be denoted as At. In one illustrative example, the size At of a blob tracker can be determined by calculating the area of a bounding box associated with the blob tracker. The size ratio of a blob tracker across two consecutive frames is denoted as SRt, and is calculated as the bigger size bounding box divided by the smaller size bounding box, ensuring the size ratio is always set to be larger than or equal to 1.

An irregular size change can be determined when a change in size of the blob tracker between a previous video frame and the current video frame (as indicated by the size ratio SRt) is greater than a size change threshold. A number of irregular size changes that the blob tracker has experienced over the duration (e.g., N or D) can be determined, and the number of irregular size changes can be compared to a threshold number of irregular size changes. The blob tracker can be considered as a possible jumping tracker when the number of irregular size changes of the blob tracker is greater than the threshold number of irregular size changes.

In some aspects, different types of irregular size changes can be detected, and different threshold numbers can apply to the different types of irregular size changes. In some examples, the different types of irregular size changes can include dramatic size changes and significant size changes. A “dramatic size change” of a blob tracker's bounding boxes from one frame to another includes a size ratio greater than a dramatic size change threshold (denoted as SRₜ>R_{d}). The term R_{d} is the dramatic size change threshold of the size ratio and can be set to any suitable value (e.g., 2, 2.5, 3, 3.5, 4, 4.5, 5, or any other suitable value). In one illustrative example, if a bounding box of a blob tracker in a previous frame is 16×8 (e.g., 128 pixels) and a bounding box of the blob tracker in a current frame is 48×8 (e.g., 384 pixels), the size ratio SRt for the bounding box for the current frame is 3 (calculated as 384 divided by 128). In the same example, if the dramatic size change threshold R_{d} is set to 2, the change in size of the blob tracker is considered a dramatic size change since the size ratio SRt of 3 is greater than the dramatic size change threshold of 2.

A “significant size change” of a blob tracker's bounding boxes from one frame to another includes a size ratio greater than a significant size change threshold (denoted as SRₜ>Rₛ). The term Rₛ is the significant size change threshold of the size ratio and can be set to any suitable value that is less than the dramatic size change threshold R_{d} (e.g., 0.5, 1, 1.5, 2, or any other suitable value). In some cases, the significant size change threshold Rₛ can be set to value that is close to, but less than, the dramatic size change threshold R_{d}. In one illustrative example, the dramatic size change threshold R_{d} can be set to 2, and the significant size change threshold Rₛ can be set to 1.5.

A number of dramatic size changes for a current blob tracker within the duration can be calculated as DC_{T}=Σₜ₌₁^{N}(SRₜ>R_{d}?1:0). In this example, N is used as the duration for illustrative purposes. The N can be replaced by D if the detection duration D is used as the duration over which to analyze the size changes. Similarly, the number of significant size changes for a current blob tracker within the duration can be calculated as SC_{T}=Σₜ₌₁^{N}(SRₜ>Rₛ?1:0). If the number of dramatic size changes DC_{T} is larger than a first threshold number C0, or the number of significant size changes SC_{T} is larger than a second threshold number C1, the current blob tracker may be considered as a jumping tracker. The threshold numbers C0 and C1 can be set to any suitable number indicating a consistent pattern of size changes. In one illustrative example, C0 can be set to 3 and C1 can be set to 6. In some examples, a mixture of dramatic size changes and significant size changes may be detected and used to detect a blob tracker as a jumping tracker. For example, if any combination of dramatic size changes and significant size changes for a current blob tracker exceeds a third threshold number C2, the current blob tracker can be considered as a possible jumping tracker. The third threshold number C2 can be set to any suitable value, and can be the same as or different than the first and second threshold numbers C0 and C1. In one illustrative example, C0 can be set to 3 and C1 and C2 can be set to 6. In another illustrative example, C0 can be set to 3, C1 can be set to 6, and C3 can be set to 5.

In some examples, the threshold numbers C0, C1, and/or C2 can be adjusted or set as different values for a new tracker than the values used for a split-new tracker. For example, in some cases, smaller values can be used for split-new trackers because the threshold duration (denoted as T2 above) for split-new trackers may be shorter than the threshold duration (denoted as T1 above) for new trackers. As described above, a threshold duration is the duration that a blob tracker must be continuously associated with one or more blobs before it is converted to a normal tracker.

The jumping tracker detection process can also identify a blob tracker as a possible jumping tracker based on irregular motion changes of the blob tracker over the duration (e.g., N or D). For example, according to the history of the bounding boxes for a blob tracker, the motion (also referred to as the velocity) of the blob tracker for each frame t can be calculated based on the centers of two bounding boxes of the blob tracker in two consecutive frames. While examples are provided herein using consecutive video frames, the same processes can be performed using two frames that are within a certain distance from one another (e.g., between frame 2 and frame 4 of a video sequence, or the like). The velocity (or motion) can be represented as a two-dimensional vector denoted as Vt. For example, as previously described, the velocity of a blob tracker can include the displacement of the blob tracker between consecutive frames.

In some examples, the irregular motion change of a blob tracker can include a motion direction consistency of the blob tracker. The motion direction consistency is based on velocities of the blob tracker between consecutive frames. For example, given two consecutive velocities Vₜ and Vₜ₋₁ (both of which can be two-dimensional vectors) for two consecutive frames, the inner product of the Vₜ and Vₜ₋₁ vectors is calculated. In some examples, the inner product can be normalized according to the length values of both vectors. The inner product equals to the cosine of the angle between the Vₜ and Vₜ₋₁ vectors, denoted as Cosₜ. The inner product provides the change in direction of the vectors Vₜ and Vₜ₋₁. For example, the inner product is equal to a value of 1 (after normalization) when the two vectors Vₜ and Vₜ₋₁ are in the same direction. As another example, the inner product is equal to a value of −1 (after normalization) when the two vectors Vₜ and Vₜ₋₁ are in opposite directions.

In some examples, the inner products between the Vₜ and Vₜ₋₁ vectors of the blob tracker between multiple pairs of consecutive frames are calculated and are accumulated. For example, the inner product (Cosₜ) results that correspond to detectable velocities (the non-zero velocities) are accumulated together to describe the motion direction consistency of the tracker. In order to avoid the cases when one or the vectors becomes too close to zero magnitude, the motion direction consistency of the blob tracker can be denoted as MIC=Σₜ₌₂^{N}(Sigₜ?Cosₜ:0)/Σₜ₌₂^{N}(Sigₜ?1:0), wherein the function Sigₜ checks whether the length of Vₜ and Vₜ₋₁ are both larger than a certain value (e.g., 1 or other suitable value), which can be used to exclude the cases when there is no motion in a certain frame for the tracker. Only if both vectors are significant, the inner product is taken into consideration for the average. For example, Sigₜ is used to avoid the case where there is no movement, in which case Vₜ or Vₜ₋₁ is 0 when there is no movement, and with a 0 velocity the inner product cannot be normalized because the Cosₜ will return an invalid value (e.g., infinity). The accumulation of the inner products is from t=2 to the duration N (or D), with t=2 being the second frame after the blob tracker was first created or last associated with a blob at t=1.

The motion direction consistency of the blob tracker can then be compared to a motion direction threshold. For example, if the motion direction consistency (calculated as MIC) is smaller than a motion direction threshold M, the motion direction consistency is determined to be too inconsistent, and the tracker is considered as a possible jumping tracker. The value of MIC is in the range of −1 to 1. The motion direction threshold M can be set to any suitable value (e.g., −0.75, −0.5, −0.25, 0, 0.25, 0.5, or other suitable value). In one illustrative example, if M is set to −0.5 (which corresponds to an angle of 120° between the vectors Vₜ and Vₜ₋₁), then the motion direction consistency of a tracker must be between 1 and −0.5, meaning a change of direction between 0° and 120°.

In some examples, the irregular motion change of a blob tracker can include a detected motion magnitude consistency of the blob tracker. The motion magnitude includes the magnitudes of the velocities of the blob tracker for each frame over the duration (e.g., N or D). For example, using N as the duration, the magnitudes of velocities Vₜ for the blob tracker over the duration is summed up as SV=Σₜ₌₁^{N}|Vt|. The summed velocity magnitudes SV is compared to a global motion magnitude. The global motion magnitude is a velocity vector that is calculated as the motion between the centers of the last bounding box (for frame t=N or t=D) and the first bounding box (for frame t=1) of the blob tracker, giving a global motion from the beginning of the tracker bounding box history to the end of the tracker bounding box history. The magnitude of the global motion is denoted as GV. The global motion GV is thus the motion between the first bounding box and the last bounding box, and the summed velocity magnitude SV is the accumulation of motion between bounding boxes of consecutive frames from t=1 to N (or D). In some cases, the global motion magnitude GV is L-2 norm based (magnitude=\sqrt{x²+y²}).

The motion magnitude of the blob tracker can then be compared to a motion magnitude threshold. For example, the summed velocity magnitudes SV can be compared to the global motion magnitude GV multiplied by a velocity threshold (denoted as VelThres). The velocity threshold VelThres may be set to any suitable value (e.g., 2, 3, 4, 5, or other suitable value). If the summed velocity magnitudes SV is less than the global motion magnitude GV multiplied by a velocity threshold (denoted as SV<VelThres*GV), the motion magnitude of the blob tracker is considered as consistent and the current tracker is not considered as a jumping tracker due to this check. For example, if the accumulated velocity of a blob tracker is less than the global velocity of the blob tracker multiplied by the velocity threshold, then the step by step motion (per frame) of the blob tracker is not large enough to be considered as a jumping tracker. Otherwise, the current tracker is considered as a possible jumping tracker. For example, if the summed velocity magnitudes SV is greater than the global motion magnitude GV multiplied by the velocity threshold (denoted as SV>VelThres*GV), the current blob tracker is considered as a jumping tracker.

In some examples, the x- and y-dimension of Vₜ as well as that of the global motion can be used to quantify the motion consistency of a blob tracker. For example, instead of using magnitude of the vector for local motion, the absolute value of the x-dimension and the absolute value of the y-dimension of Vₜ can be determined and added up. The summed value can be used instead of the magnitude. In one illustrative example, a vector with a magnitude of 5 can have a x-dimension value of 3 and a y-dimension value of 4, and the summed x- and y-dimension values are 7. The 7 value can be used instead of the 5 value in the motion consistency calculation. Similarly, the absolute value of the x-dimension and the absolute value of the y-dimension of the global motion can be used to in the motion magnitude consistency calculation. In such examples, the summed x- and y-dimensions of the velocity vectors of the blob tracker over the duration can be compared to the global motion x- and y-dimensions to determine the consistency of the motion magnitude for the blob tracker.

In some examples, the motion magnitude can be compared to the size of the current bounding box. For example, the size of the bounding box can be determined as its width and height (e.g., sum of width and height, product of the width and height, or the like), and the motion of the bounding box is determined from its center point. Here, the magnitude can be normalized according to the size of the bounding box. The velocity threshold VelThres used for motion magnitude consistency can thus be adjusted according to the size of the bounding box currently being analyzed. For example, for bigger bounding boxes, the velocity threshold VelThres may be lowered.

In some situations, it may be suitable to implement a less aggressive irregular motion-size detection process. For example, there are cases when the motion of an object in a scene is at least partially perpendicular to the image plane (e.g., an object moving towards the camera or moving away from the camera). In such cases, even when the motion is relatively significant, the SV or other summed up local motion according to center position movement of an object will be relatively small, leading to a tracker associated with a real object being detected as a jumping tracker and the object being transitioned to the intermediate state (“next round”). In such situations, the relevant thresholds can be adaptively adjusted to make them larger (thus less aggressive) based the content in a scene.

To implement less aggressive jumping tracker detection, a half-way global motion (denoted as Vₕ) of a blob tracker can be calculated. The half-way global motion Vₕ is derived from the center positions of two bounding boxes of the blob tracker at two relative timestamps 1 and N/2, with N/2 being the frame halfway between the original frame for which the blob tracker was created and the duration N (in some cases, N can be replaced with D). The magnitude of Vₕ is then derived and scaled by a value (e.g., a value of 2, 3, or other suitable value). The magnitude of Vₕ is denoted as GVH, with GVH=|Vₕ|. The ratio between GVH and GV is calculated as r=min (GVH, GV)/max (GVH, GV). The velocity threshold VelThres can then be set to be a function of r. The GVH and GV are compared to one another because ideally the GVH and GV values should be proportional over the duration N (or D) of a blob tracker, assuming uniform motion. If GVH and GV are consistent, then the velocity threshold VelThres can be left unchanged. However, if GVH and GV are inconsistent (as indicated by the ratio r), then the velocity threshold VelThres can be adjusted according to the ratio r.

In some cases, there can be situations when none of the above jumping tracker checks (e.g., size change, motion direction consistency, and motion magnitude consistency) individually leads to a blob tracker being detected as a possible jumping tracker. In some examples, the factors of the above jumping tracker checks can be jointly considered to determine whether a blob tracker is a possible jumping tracker. For example, if the comparisons of the various characteristics are close to the conditions for each jumping tracker check (within a certain percentage, such as 5%, 10%, 15%, or any other suitable value), the blob tracker can be considered as a possible jumping tracker.

As described above, if the current tracker is detected as a freeze tracker (a positive result at block 604) or a jumping tracker (a positive result at block 606) at a detection frame during the first key frame cycle T, the current tracker will be assigned an intermediate status (“next round”) at block 608. A tracker having the intermediate status is maintained for further analysis by the sub-process 600A and/or the sub-process 600B at a next detection frame (at a next detection duration D), instead of being killed and removed from a set of blob trackers being maintained for the video sequence. If the current tracker is not detected as a freeze tracker (a negative result at block 604) or a jumping tracker (a negative result at block 606), the true-false positive detection process continues by performing the true-false positive detection sub-process 600B (starting with the true-false positive detection analysis at block 610) for the current tracker.

The sub-process 600B of the true-false positive detection process is shown in FIG. 6B. As shown in FIG. 6B, except for the AMFR process (at block 622), if the false positive removal results are positive for a current tracker, the current tracker is output at block 636. For the AMFR process, a positive determination (at block 622) results in the intermediate (next round) status being assigned to the blob tracker, while a negative determination results in a determination of whether the current frame is a key frame. In some cases, such a determination can begin at the second key frame cycle (e.g., at key frame 60 for a key frame cycle T of 30). For example, starting from the second key frame cycle, if the current frame is a key frame (e.g., frame 60, 90, 120, or the like for a key frame cycle T of 30), the current blob tracker will be killed at block 626 (and removed from the set of trackers maintained for the video sequence).

Similar to that shown for the sub-process 600A illustrated in FIG. 6A, the sub-process 600B includes the block 612, the block 614, and the block 601. For example, the sub-process 600B can check the history duration N of the current blob tracker at block 612, and can determine whether the detection duration D has been met by the history duration N at block 614. If the detection duration is met for a current tracker (N % D is equal to 0), the sub-process 600B continues to block 601 and determines whether the current blob tracker is within its first key frame cycle T. As noted above, if the current video frame is within the current blob tracker's first key frame cycle T, the current tracker is determined to be a one cycle tracker at block 602. If the current video frame is after the first key frame cycle T for the tracker, the sub-process 600B performs the True-False Positive Detection Analysis at block 610. While the blocks 612, 614, and 601 are shown for both the sub-processes 600A and 600B, one of ordinary skill will appreciate that the blocks 612, 614, and 601 can be performed only a single time when performing the true-false positive detection process (including the sub-processes 600A and 600B).

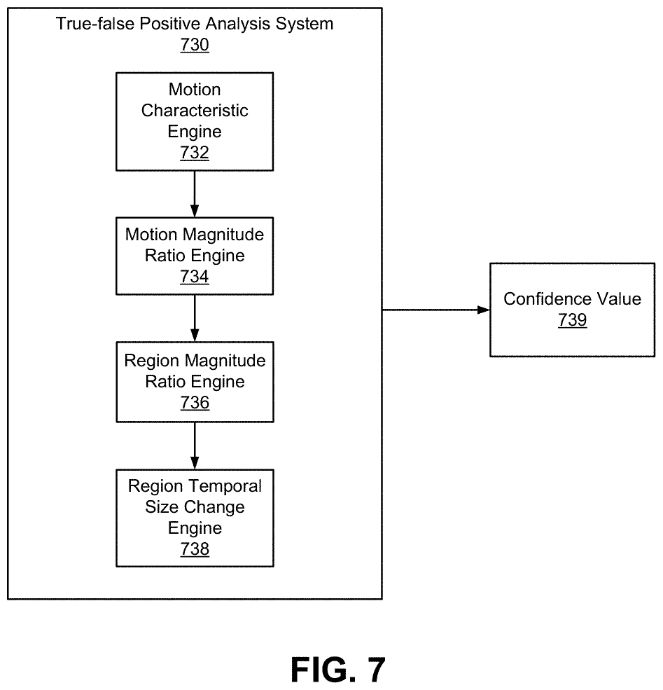

The true-false positive detection analysis performed at block 610 can include determining one or more characteristics or features extracted from a bounding box history of a tracker, and utilizing the characteristics or features individually or jointly to generate a confidence value (or confidence level) for the tracker. While a bounding box history of a tracker is used herein as an illustrative example, a bounding region history other than a bounding box history can be used (e.g., a history of bounding circles used to track an object, or other suitable shape). Further details relating to the true-false positive detection analysis and the determination of the confidence values are described below with respect to FIG. 7.

The true-false positive detection analysis performed at block 610 can provide a confidence value for the current blob tracker. A confidence value for a tracker may fall into different confidence ranges, such as a very high confidence range (higher than a first confidence threshold TC1), a high confidence range (between a first confidence threshold TC1 and a second confidence threshold TC2), a low confidence range (between a second confidence threshold TC2 and a third confidence threshold TC3), and a very low confidence range (less than the third confidence threshold TC3), with the several thresholds TC1, TC2, and TC3 being between the different ranges. Illustrative examples of the different confidence thresholds TC1, TC2 and TC3 can include 10, 2, and 1, respectively. One of ordinary skill will appreciate that other suitable values for the confidence thresholds TC1, TC2, and TC3 can be used. If the confidence value of a current blob tracker is larger than TC1, the current blob tracker will be in the very high confidence range. If the confidence value of the tracker is larger than TC2 and less than TC1, it will be in the high confidence range. If the confidence value of the tracker is less than TC2, but greater than TC3, it will be in the low confidence range. If the confidence value of the tracker is smaller than TC3, it will be in the very low confidence range.

In some cases, the highest confidence range (greater than TC1) can lead to immediate output of the current tracker. Trackers in the high and low range can be transitioned to an intermediate status (denoted as “Next Round”) in some cases, which keeps the trackers for a next round of analysis by the true-false positive detection process (including sub-processes 600A and 600B). When the confidence level is in the very low range (e.g., less than TC3), instead of directly killing the tracker, the AMFR process can be performed, as described below.

As noted above, when the confidence value of a tracker is very high (greater than the first confidence threshold TC1), the tracker may be determined to be a true positive (turned to output as a normal tracker). For example, at block 618, the sub-process 600B can determine whether the confidence value of a current tracker is less than the first confidence threshold TC1. If the confidence value of the current tracker is not less than the first confidence threshold TC1, the current tracker is output at block 620 (e.g., at the current frame, after the current frame is processed, or other time suitable for outputting trackers). In some cases, block 618 can determine whether the confidence value of the current tracker is greater than the threshold TC1, and if the confidence value is greater than the threshold TC1, the tracker is output at block 620. If the confidence value of the current tracker is less than TC1 (or is not greater than TC1), the sub-process 600B proceeds to block 621.

When the confidence value of a tracker is very low (less than the third confidence threshold TC3), instead of directly killing the tracker, an Appearance Model based False positive Removal (AMFR) process can be performed, as described below. The AMFR process can be a strong indicator of a false positive. In some cases, the AMFR process can be a good indicator of false positives when the motion of an object for the current tracker being tested is relatively small or irregular. For example, as described in more detail below, the AMFR process can determine that the texture of an object being tracked remains similar in a previous frame and a subsequent frame (e.g., a small distance between the mass center of the previous frame C₀ and the subsequent frame Cₜ). The similarity in texture indicates that the object remains in the scene in the subsequent frame at relatively the same location as when the initial appearance model was created in the prior frame. The non-moving (or little moving) object can be considered as false positive.

The AMFR process is a pixel level analysis, and works as a strong indication of whether a current object is true positive or a false positive. In addition, in some implementations, since the AMFR process requires pixel level calculations, the bounding box history of a blob tracker can be used to reduce complexity in the true-false positive detection process.

The AMFR process can use appearance characteristics, which can include color characteristics (e.g., an appearance model, a color mass center, and/or other color characteristics) that are determined for a tracker. The color characteristics can be based on the pixels in a region of a frame included in a tracker's bounding region (e.g., a bounding box of the tracker). Color characteristics of a tracker can be determined in multiple frames of a video sequence, and can be compared to determine a difference between the color characteristics in the multiple frames. The status of the blob tracker can then be determined based on the difference between the color characteristics. For example, a determined status of a tracker can include outputting the tracker immediately, removing the tracker from a list of trackers maintained for the video sequence (also referred to as killing the tracker), and transitioning the tracker to an intermediate status. As noted above, a tracker with an intermediate status can be kept or maintained for future iterations of the true-false positive detection process, in which case there is no need to either kill or output the tracker immediately.

In some examples, the color characteristics of a blob tracker can be represented using one or more appearance models determined for the blob tracker. An appearance model of a tracker can includes one or more color characteristics of pixels (of a video frame) included in a bounding box of the tracker. For example, the one or more color characteristics can be calculated using the values of pixels of a given frame that are included within the bounding box of the tracker. In some examples, the one or more color characteristics of an appearance model can include a color feature space (e.g., a histogram) of pixels included in the bounding box, a color mass center of pixels included in the bounding box, or a combination thereof. In some cases, the color feature space includes a histogram statistically describing the color characteristics of a patch of pixels in a video frame within a tracker bounding box. In some implementations, the color feature space can be the quantized color spaces, using the luminance (Y) and hue (H) components of an HSV color space. In some implementations, the features of the feature space may be from the Y, U and V components of a YUV color space (e.g., the YUV 4:2:0 space, YUV 4:4:4 space, YUV 4:2:2 space, or other suitable YUV color space). Any other suitable color space can be used.

In some examples, the color mass center (or mass center) of a tracker can be calculated using an appearance model of the tracker, such as by counting the mass center of the feature space applied to the pixels of a given frame that are within the bounding box of the tracker. For instance, an appearance model (e.g., a color probability model, histogram, or the like) can first be determined. For example, a color probability model may be determined by calculating the probability of the feature value in each pixel location. The mass center of all pixels within the whole bounding box can then be calculated according to the per-pixel probability model.

In some implementations, when calculating the color probability model, the color space of the tracker bounding box may need to be quantized so that the probability model is limited to contain only up to a fixed number of entries (e.g., 1024 for Y and H component or 2048 for YUV). In some cases, when calculating the color mass center, the pixel locations may also need to be quantized. For example, when contributing to the calculation of the mass center, the X and Y coordinate may be quantized (e.g., by a right shift of 2 (divided by 4), or other suitable amount) such that the bounding box is divided into small grids. Even though each pixel within a grid may have a different probability, each pixel's coordinates are considered the same when calculating the mass center. Using such quantized pixel locations can allow the AMFR process to be more robust to distortions (e.g., a small phase shift of the pixels of input images).

Detailed implementations of an appearance model are now described as illustrative examples. An illustrative example of an implementation of the YUV color probability model includes (Note that this process establishes an appearance model which is illustrated by a histogram array denoted as HIST):
1. Initialize the color histogram HIST to all zeros.
2. For each pixel P in the bounding box, get its Y, U, V components, each components are 8 bits.
3. Quantize the YUV components as Y=Y>>3, U=U>>5, V=V>>5; [with >> being a right bit shift operator]
4. The HIST index is given by idx=(Y<<6)+(U<<3)+V; [with <<being a left bit shift operator]
5. Then increase the HIST(idx) by 1.
6. Finally, HIST is normalized by the bounding box size.

An illustrative example of an implementation of the mass center calculation includes:
1. Initialize the mass center (CX, CY) as (0, 0). Set the sum of probability P_SUM=0.
2. Given the color histogram HIST, for each pixel P in the bounding box, get its Y, U, V components and do the following:
3. Quantize the YUV components as Y=Y>>3, U=U>>5, V=V′>5;
4. The HIST index is given by idx=(Y<<6)+(U<<3)+V;
5. P_SUM=P_SUM+HIST(idx)
6. Get the pixel coordinates X and Y.
7. Update the mass center as CX=CX+(X>>2)*HIST(idx), CY=CY+(Y>>2)*HIST(idx).
8. Finally, normalize the (CX, CY) by the P_SUM.

Note that, in the frame at which an appearance model is just calculated, its mass center can be calculated (similarly as in step 6 and step 7) in order to know the initial mass center of the appearance model. In some cases, the appearance model of each tracker bounding box is designed in a way that all pixels of a bounding box are maintained. In other cases, the appearance model of each bounding box is designed in a way that it is always of a constant size regardless of the bounding box size. In such cases, the possibility of uncontrollable memory increase is avoided, which may occur when multiple large bounding boxes exist.

In some implementations, an initial appearance model (e.g., a color probability model, histogram, or the like) together with a target bounding box may be created for a new tracker (or split-new tracker) in the frame at which the tracker is initially created (or split). For example, the tracker bounding box tracking the object in the frame can be designated as the target bounding box, and pixels of the frame within the target bounding box can be used to create the initial appearance model.

In some implementations, instead of creating the initial appearance model and the target bounding box in the first frame at which a new tracker is created (or a split-new tracker is split), the initial appearance model and the target bounding box can be created with a delay, which can remove temporal noise. The delay is denoted as a duration Tc, which can be related proportionally (or as a monotonic increasing function) to T in case of new tracker and to Ts in case of a split-new tracker, where T and Ts are the key frame durations for a new tracker or split-new tracker, respectively. In one illustrative example, Tc is set to T/2 in case of a new tracker and Ts/2 in case of a split-new tracker. In some cases, the duration Tc can be equal to the initial threshold T₀ described above. When the duration of a tracker (since the tracker was created or when it was split) is Tc frames, the initial appearance model as well as the target bounding box is calculated and maintained. In some cases, as described in more detail below, an initial mass center C₀ is calculated when the initial appearance model is created. For example, the initial appearance model (e.g., the histogram or probability model) can be used to calculate the initial mass center C₀.

In some cases, before an object is being identified as a true positive and output to the system, the appearance model for the tracker (tracking the object) is kept unchanged (is kept as the initial appearance model), in order to avoid potential complexity related to updating the appearance model.

An object tracking system, using the AMFR process, can use the initial appearance model and the target bounding box to determine a mass center (Cₜ) of the pixels associated with the tracker in one or more future frames, which can be used for comparison with the initial mass center C₀ of the tracker before an object the tracker is tracking (and the tracker) is determined to be a true positive or a false positive object. For example, the AMFR process can compare appearance models (or information calculated using the appearance models, such as a color mass center or other information) of the tracker to determine if color characteristics of the tracker in two frames are similar enough to consider the tracker as false positive. Such a comparison of color characteristics can be used to determine that the texture (color) of the object being tracked remains similar in the two frames, which indicates that the object remains in the scene in the subsequent frame at relatively the same location as when the initial appearance model was created in the prior frame. The non-moving (or little moving) object can be considered as false positive.

In some examples, once there is a need to perform true-false positive detection in a current frame (e.g., when the detection duration D is met) and when it is determined that pixel level analysis is required and that there is a need to invoke the AMFR process, the initial appearance model as well as the target bounding box of a tracker can be used to calculate the mass center Cₜ of the current frame. For example, the initial appearance model can include a color probability model that may be determined by calculating the probability of the feature value in each pixel location within the target bounding box in the previous frame at which the target bounding box was created. The mass center Cₜ can then be determined by calculating the mass center of all pixels within the current bounding box of the blob tracker in the current frame according to the per-pixel probability model of the initial appearance model. The distance between C₀ and Cₜ can then be calculated (denoted as ∥C₀−Cₜ∥) and compared with a threshold distance (also referred to herein as a threshold difference). In one illustrative example, the threshold distance can be set to a percentage of the diagonal distance of the target bounding box (e.g., less than 1%, 2%, or other suitable value of the diagonal distance). If the determined distance between C₀ and Cₜ is less than the threshold distance, the AMFR process can identify the object as a false positive object. The object can be removed or transitioned to the intermediate status (“next round”).

If the distance between the mass centers C₀ and Cₜ is within the threshold distance, the tracker (and the object it is tracking) can be considered a false positive object and can be removed or transitioned to the intermediate status in some cases (“next round”). For instance, a small distance between the mass centers C₀ and Cₜ means the texture of a patch (included in a previous bounding box of the tracker) in the initial frame is similar to the texture of the patch (included in a current bounding box of the tracker) in the current frame. The patch in the initial frame being similar to the patch in current frame can statistically mean that the patch may have changed slightly between the frames, but statistically, the patch (and thus the tracker) is kept in the same location and thus is not moving. A non-moving patch is considered as a false positive (e.g., due to the characteristic that true positive objects consistently move in a scene), and thus the tracker can be considered as a false positive tracker.

Returning to FIG. 6B, when the confidence level is in the very low range, the AMFR process can be performed to check the appearance of the tracker before possibly killing the tracker. For example, at block 621, the sub-process 600B can determine whether the confidence value of a current tracker is greater than the third confidence threshold TC3. If the confidence value of the current tracker is not greater than the third confidence threshold TC3, the AMFR process is performed at block 622. In some cases, block 621 can determine whether the confidence value of the current tracker is less than the threshold TC3, and if the confidence value is less than the threshold TC3, the AMFR process is performed at block 622.

As described above, the AMFR process includes comparing the initial appearance model (e.g., the histogram/color probability model) and the target bounding box of the current tracker with an appearance model of the current tracker determined using information in the current frame. For example, as previously described, the initial appearance model can be used to calculate the mass center C₀ of the pixels included in the target bounding box of the tracker in the initial frame at which the initial appearance model was created (at Tc). The initial appearance model can also be used to calculate the mass center C₁ of the pixels included in the current bounding box of the tracker in the current frame. The mass center Cₜ can then be compared with the mass center C₀ to determine whether the current tracker (and the object being tracked by the tracker) is a false positive.

If the distance between the mass centers C₀ and Cₜ is within a threshold distance, the tracker (and the object it is tracking) can be considered a false positive object and can be removed depending on whether the current video frame is a key frame, as described below. In one illustrative example, the threshold distance can be set to a percentage of the diagonal distance of the target bounding box (e.g., less than 1%, 2%, or other suitable value of the diagonal distance). A distance between the mass centers C₀ and Cₜ that is below the threshold distance indicates that the texture of a patch (included in the target bounding box of the tracker) in the initial frame is similar to the texture of the patch (included in the current bounding box of the tracker) in the current frame, and is used to determine that tracker (and the tracked object) is a false positive. When the distance is determined to be below the threshold distance, a negative result is returned at block 623 based on the AMFR process performed at block 622. When the distance is determined not to be below the threshold distance (or determined to be greater than the threshold distance), a positive result is returned at block 623.

If the AMFR process returns a positive result at block 623, the tracker can be considered as possibly not being related to a false positive object, and can be transitioned to the intermediate status at block 625 (“next round”). A tracker having the intermediate status can kept in the buffer for the next round of the true-false positive detection process.

At block 623, if the AMFR process returns a negative result (the distance between the mass centers C₀ and Cₜ is below the threshold distance), the sub-process 600B determines whether the current video frame is a key frame at block 624. For example, if the condition historyduration_{T}% T==0 is met, the sub-process 600B determines the current frame is a key frame. The historyduration_{T} denotes the history duration of the current blob tracker during the current key frame cycle. The notation x % T indicates the modulo operation between x and T. For example, the modulo operation x % T finds the remainder after a division of x by T. When the history duration (during the current key frame cycle) for a blob tracker reaches the key frame cycle, in which case the value of historyduration_{T} and T are the same, no remainder is met, thus satisfying the condition historyduration_{T}% T==0. In one illustrative example, if the key frame cycle T is set to be equal to 30 frames, and the current video frame is frame 75 and thus is during the third key frame cycle (n*T, with n=3), then the historyduration_{T} is set to a value of 15. The modulo of 15%30 does not equal 0, thus not satisfying the condition historyduration_{T}% T==0. When the condition is not met, the sub-process 600B will return a negative result at block 624 for the current blob tracker, in which case the current blob tracker will be assigned the intermediate status (“next round”) at block 625.

In one illustrative example, if the key frame cycle T is set to be equal to 30 frames, and the current video frame is frame 90 and thus is during the third key frame cycle (n*T, with n=3), then the historyduration_{T} is set to a value of 30. The modulo of 30%30 is equal 0 (due to no remainder being left over after dividing 30 by 30), thus satisfying the condition historyduration_{T}% T==0. When the condition is met, the current blob tracker will be killed at block 626 (and removed from the set of trackers maintained for the video sequence).

If the confidence value of the current tracker is greater than TC3 (or is not less than TC3), the sub-process 600B proceeds to block 627. When the confidence value for a tracker is high (between the first confidence threshold TC1 and the second confidence threshold TC2) or when the confidence level is low (between the second confidence threshold TC2 and the third confidence threshold TC3), the tracker may go through some pixel level confirmation analysis. The pixel level analysis may be applied as a supplementary way of determining whether the current object (being tracked by the current tracker) is a true positive or a false positive object. In some cases, when the confidence level of a tracker is in a certain range (either high or low), the pixel level analysis may apply to determine whether the current tracker is to be output immediately or to be transitioned to the intermediate status (kept for a “Next Round” without removing the tracker). In such cases, tracking delay may be greatly reduced for the tracker and the object it is tracking. In some cases, a tracker with a low or high confidence level may be killed if the pixel level analysis is not positive for the tracker.

In some implementations, trackers in two different confidence ranges may have different types pixel level analysis applied to them in order to further reduce false positives. For example, when the confidence value for a tracker is larger than or equal to TC2, a lightweight pixel level analysis described below may be applied (e.g., a correlation based analysis). In another example, when the confidence level of a tracker is smaller than or equal to TC2, a strong pixel level analysis described below may be applied (e.g., application of both AMFR and a correlation based analysis). A lightweight pixel level analysis module requires less complexity as compared to a strong pixel level analysis module; the system design may rely on the confidence level of a tracker to determine whether more complexity should be used during the true-false positive detection sub-process 600B for a tracker. Applying the pixel level analysis only for certain ranges and even allowing a lightweight version of the pixel level analysis can reduce the complexity of the whole process to a much lower level, as compared to always applying pixel level analysis.

As noted above, the true-false positive detection sub-process 600B can apply a lightweight pixel level analysis at block 632 and a strong pixel level analysis at block 628. In some implementations, the strong pixel level analysis may include both AMFR and a Correlation based False positive Removal (CFR) to determine whether a current object is a true positive or a false positive. In such implementations, only when both AMFR and CFR determine the current object is a true object, the strong pixel level analysis returns a positive result. The lightweight pixel level analysis can include only the CFR, in which case the lightweight pixel level analysis returns a positive result when the CFR determines the current object is a true object. In some cases, when the strong pixel level analysis or the lightweight pixel level analysis returns a negative result, the current object (and its tracker) can be determined to be a false positive object or can be transitioned to the intermediate status (“next round”). In some implementations, the lightweight pixel level analysis and the strong pixel level analysis can include a Fullness based False Positive Removal (FFR) process in addition to the AMFR and/or CFR.

To perform CFR, the true-false positive detection process can determine a correlation between the current texture of the blob (representing the object) associated with the current tracker in the current frame and the co-located texture of a mean background picture (referred to herein as a mean picture). The mean picture can be synthesized using the background models maintained by a background subtraction engine (e.g., background subtraction engine 312). For example, each pixel location in a mean picture can be generated based on a respective background model maintained for each pixel location. There are several ways to generate a mean picture. In one example, a mean picture can be synthesized using the values of a statistical model (e.g., a Gaussian model) maintained for each pixel location in the mean picture, regardless of whether a current pixel belongs to a background pixel or foreground pixel.

In another example, a mean picture can be generated using a Gaussian mixture model (GMM) for each pixel location. For example, a pixel value of a synthesis mean picture for a pixel location can be set as the expectation (or average or mean) of a model from the GMM for that pixel location, without taking into account whether the current pixel belongs to a background pixel or foreground pixel. In some examples, the model is chosen as the most probable model, which is the model with a highest weight from the GMM for a current pixel location can be used to synthesize the mean picture for that pixel location. The model with the highest weight from a GMM is referred to herein as the most probable model. In some examples, the model from the GMM for a current pixel location whose distance to the current input pixel (in a current frame) is the smallest among all the existing models in the GMM for the current pixel location can be used to synthesize the mean picture for that pixel location. The model from a GMM for a pixel location with the smallest distance to the current input pixel is referred to herein as the closest model.

In some implementations, the most probable model or the closest model can always be used to generate the mean (or expected) pixel values for the various pixel locations of the mean picture. In some implementations, a closest background picture can be used, which can selectively choose a model to use for updating a pixel location, instead of always using a certain model (e.g., only the most probable model of the closest model). For example, the closest mean picture selects for each of its pixel locations either the most probable model when a current pixel is identified to be a foreground pixel, or the closet model when the current pixel is identified to be a background pixel. As noted above, the most probable model for a pixel location is the model (e.g., from the GMM) that has the highest weight. The closest background model is the model whose distance to the current input pixel is the smallest among all the existing models for the current pixel location. As described by Equation 1 above, the intensity of each pixel location can be modelled by a mixture of K Gaussian Models. Each model has its own weight, mean and variance. The intensity of each pixel location of the mean picture is the mean of the selected Gaussian Model of that location. If, in current frame, the current pixel location is determined as a foreground pixel, then the intensity of the background has to be estimated or guessed. The most possible intensity value is the mean μᵢ of the most probable model (the model with highest weight wᵢ) among the K Gaussian Models. If, in the current frame, the current location is determined as a background pixel, then the model which best represents the intensity of pixel location in the current frame is selected out of the K Gaussian models. For example, if the intensity of a pixel location in the current frame is p, the μᵢ which is closest to p than all other μⱼ (where j=1, . . . , K, j !=i) can be selected as the intensity of the mean picture for the current location.

A correlation can be calculated between the texture of the current blob associated with the current tracker (for the current picture) and a corresponding, co-located texture of the mean picture. For example, the pixel values of the current blob in the current picture can be compared to pixel values in the mean picture that are in the same coordinate locations as the pixels in the current picture (e.g., a correlation can be calculated for pixels located at a 0,0 coordinate of the current frame and the mean picture). A correlation (also referred to as a correlation coefficient) is a number that quantifies some type of correlation and dependence, meaning statistical relationships between two or more random variables or observed data values. In some examples, a correlation can have values in the range of −1 to 1, inclusive. In one illustrative example, the correlation (co) can be defined as co=COV(X,Y)/Sqrt(COV(X,X)*COV(Y,Y)). The covariance COV(X,X) is the variance of X (denoted as VAR(X)), and the covariance COV(Y,Y) is the variance of Y (denoted as VAR(Y)). The covariance of X and Y is defined as COV(X,Y)=E((X−E(X))(Y−E(Y))). E(X) is the expectation of X (or average of X), and E(Y) is the expectation of Y (or average of Y). In some cases, when background subtraction only applies for the luminance component, the correlation may apply only in the luminance domain, instead of the YUV or RGB domain.

A high correlation value (e.g., higher than a correlation threshold) between the texture (pixel values) of a current frame and the co-located texture (pixel values) of the mean picture indicates that the textures are expected to be statistically similar (e.g., linearly or other statistical relationship) and thus may be considered as false positives because the background texture is similar to the current texture. For example, the background texture of the mean picture indicates the texture of the background area, and the high correlation indicates the similarity of the two textures. If the texture of the patch in the current frame (of the current blob) is statistically similar to the texture of the co-located patch (based on the high correlation value) in the background represented by the mean picture, the patch in the current frame is also statistically likely to be a background patch, in which case the object represented by the current blob (and the corresponding tracker) can be considered as a false positive.

As noted above, in some cases, the lightweight pixel level analysis and the strong pixel level analysis can include a Fullness based False Positive Removal (FFR) process in addition to the AMFR and/or CFR. The FFR process can rely on a foreground pixel fullness (FPF) ratio to determine false positive blobs (and the objects represented by the blobs). The FPF ratio can be determined based on a ratio between a foreground area within a bounding box and the area of the bounding box. The foreground area can be determined based on, for example, a number of pixels associated with the foreground, whereas the bounding box area can be determined based on a number of pixels associated with bounding box. As part of the FFR process, the FPF ratio of an object can be compared against a FPF threshold. If the FPF ratio of the object equals or exceeds the FPF threshold, it may be determined that the blob (and the associated object) is likely to be a true-positive blob (and object). If the FPF ratio is below the threshold, it may be determined that blob (and object) is likely to be a false object. In some cases, the strong pixel level analysis (AMFR and CFR) can include the FFR process to reduce the likelihood that a false object is misidentified as a true-positive object due to, for example, lack of foreground pixels for performing accurate appearance model and correlation. Similarly, the lightweight pixel level analysis can include the FFR process.

Returning to FIG. 6B, at block 627, when the confidence value for a current tracker is determined not to be greater than the second confidence threshold TC2 (indicating a low confidence level), the strong pixel level analysis is performed at block 628. As described above, the strong pixel level analysis module can perform both AMFR and CFR. In some cases, the CFR may include a correlation between one or more color components (e.g., one, two, or three color components) of pixels within a bounding box of the current tracker. In some implementations, as shown in FIG. 6B, if the strong pixel level analysis returns a positive result at block 630 (e.g., AMFR determines the distance is greater than the threshold distance and the correlation is determined to be below the correlation threshold), the tracker can be output at block 636 (e.g., immediately for the current frame, once all trackers for the current frame have been processed, or at some other time). In such implementations, if the strong level pixel analysis returns a negative result at block 630 (e.g., AMFR determines the distance is less than the threshold distance and/or the correlation is determined to be above the correlation threshold), the sub-process 600B determines whether the current video frame is a key frame at block 631. For example, if the condition historyduration_{T}% T==0 is met, the sub-process 600B determines the current frame is a key frame. When the condition is met, the current blob tracker will be killed at block 626 (and removed from the set of trackers maintained for the video sequence). When the condition is not met, the sub-process 600B will return a negative result at block 625 for the current blob tracker, in which case the current blob tracker will be assigned the intermediate status (“next round”) and kept in the memory at block 625 for the next round of analysis by the true-false positive detection sub-process 600B.

If, at block 627, the confidence value for a tracker is determined to be greater than the second confidence threshold TC2 (indicating a high confidence level), the lightweight pixel level analysis is performed at block 632. As described above, the lightweight pixel level analysis module may, for the current bounding box, perform only CFR to check the correlation between the current frame and a mean picture. If the correlation is determined to be below a correlation threshold, indicating a low correlation, a positive result is returned at block 634. When a positive result is returned at block 634, the tracker can be output at block 636 (e.g., immediately for the current frame, once all trackers for the current frame have been processed, or at some other time). If the correlation is determined to be above the correlation threshold, indicating a high correlation, a negative result is returned at block 634. When a negative result is returned at block 624, the sub-process 600B determines whether the current video frame is a key frame at block 631. As noted above, if the condition historyduration_{T}% T==0 is met, the sub-process 600B determines the current frame is a key frame. When the condition is met, the current blob tracker will be killed at block 626 (and removed from the set of trackers maintained for the video sequence). When the condition is not met, the sub-process 600B will return a negative result at block 625 for the current blob tracker, in which case the current blob tracker will be assigned the intermediate status (“next round”) and kept in the memory at block 625 for the next round of analysis by the true-false positive detection sub-process 600B.

In some cases, when FFR is used, if the result of the pixel level analysis (the lightweight or the strong level pixel level analysis) and the result of the FFR analysis are positive (at block 630 and/or block 634), the tracker (and the corresponding blob and object) can be considered as a true-positive, in which case the tracker can be transitioned to the normal state and output at block 636. If the result of the pixel level analysis and the FFR analysis are different, or both analyses provide a negative outcome, the true-false positive detection sub-process 600B can determine whether the current video frame is a key frame at block 631.

As described above, the true-false positive detection analysis is performed at block 610 when the detection duration D is met for a current tracker, as described above. The true-false positive detection analysis can determine one or more characteristics of a current blob tracker (in a current frame) using a bounding box history of the tracker. FIG. 7 is a block diagram illustrating an example of a true-false positive detection analysis system 730 that can perform the true-false positive detection analysis. The bounding box history of a tracker can include the bounding boxes of the blob tracker in one or more previous frames that are earlier in the video sequence than the current frame and thus are obtained by the true-false positive detection process prior to the current frame. The bounding boxes of the tracker in the previous frames can be identified by a unique tracker identifier (ID) associated with the tracker. The bounding box history of the tracker can also include the locations, sizes, and/or other features of the bounding boxes in the bounding box history.

The characteristics of a tracker can include a motion characteristic determined by the motion characteristic engine 732, a motion magnitude ratio determined by a motion magnitude ratio engine 734, a region magnitude ratio determined by a region magnitude ratio engine 736, a region temporal size change determined by a region temporal size change engine 738, and/or any other suitable characteristic of a tracker. As described in more detail below, the characteristics determined for a current tracker can be used individually or jointly to generate a confidence value 739 indicating a confidence level that the current tracker is a true-positive. The confidence value 739 is output for further analysis by the true-false positive detection sub-process 600B, as described above.

The motion characteristic (or feature) can be referred to as “full-body motion” of a tracker. The motion characteristic can be defined as the maximum movement of the tracker from either the vertical direction or the horizontal direction in units of object height (for vertical) or width (for horizontal). In one illustrative example, the motion characteristic engine 732 can determine the motion characteristic of the tracker by determining an average width (avgWidth) and an average height (avgHeight) of the bounding boxes of the tracker through all bounding boxes in the bounding box history (e.g., from the first previous video frame in the history to the current video frame). The motion characteristic engine 732 can also determine a global movement of the tracker. The global movement can be calculated using the center positions of the first and last bounding boxes in the history for the x-coordinate (horizontal direction) and the y-coordinate (vertical direction) separately. Such horizontal and vertical movement is denoted as globalMoveX and globalMoveY, respectively. For example, the motion characteristic engine 732 can determine an amount of movement of a bounding box of the tracker from its location in the first previous frame of the history to the current location of the bounding box of the tracker in the current frame, both in the horizontal direction (globalMoveX) and in the vertical direction (globalMoveY). The motion characteristic (or full-body motion) can then be determined as the maximum value from among the amount of movement of the bounding region in the horizontal direction divided by the average width and the amount of movement of the bounding region in the vertical direction divided by the average height. Such a calculation can be denoted as—full-body motion is calculated as Max(abs(globalMoveX)/avgWidth, abs(globalMoveY)/avgHeight).

If the full-body motion (the motion characteristic) is more than a first motion characteristic threshold (denoted as Tf1), the confidence value is increased by a first amount (e.g., by 8, 9, 10, or other suitable amount). The first motion characteristic threshold Tf1 can be set to any suitable value, such as a value of 2. If the full-body motion is more than a second motion characteristic threshold (denoted as Tf2), but less than the first threshold Tf1, the confidence value is increased by a second amount (e.g., by 1, 2, 3, 4, or other suitable amount). The second motion characteristic threshold Tf2 can be set to any suitable value (e.g., a value of 1) that is less than the value of the first motion characteristic threshold Tf1. In some cases, if the full-body motion is less than the second motion characteristic threshold Tf2, the confidence value for the tracker is not increased or decreased. In some cases, the confidence value for the tracker can be decreased by some amount if the full-body motion is less than the second motion characteristic threshold Tf2.

The motion magnitude ratio can be determined by the motion magnitude ratio engine 734 by comparing the step-by-step accumulated motion magnitude of the tracker with the global motion magnitude of the tracker. Motion of a tracker can also be referred to as velocity. The magnitude of the motion (or velocity) associated with the current tracker of each frame is denoted as velMagnitude, and can be calculated by the center position of two temporally consecutive bounding boxes' center positions in two consecutive frames (by L-2 norm). The sum of the velMagnitude for all the frame pairs in the bounding box history can be calculated and denoted as sumVelMag. For instance, the sumVelMag indicates the accumulated motion between consecutive video frames of bounding boxes in the bounding box history of the current tracker (e.g., velMagnitude of the tracker bounding box from frame 1 to frame 2 plus the velMagnitude of the tracker bounding box from frame 2 to frame 3, and so on until the current frame is reached). The magnitude of the global motion (globalMoveX, globalMoveY) can also be calculated (by L-2 norm), in a similar manner as that described above for the motion characteristic. The magnitude of the global motion is denoted as globalMagnitude. The motion magnitude ratio is then calculated as sumVelMag/globalMagnitude.

If the motion magnitude ratio is smaller than first motion ratio threshold (denoted as Tm1), the confidence value of the tracker is increased by a first amount (e.g., by 2 or other suitable amount). The first motion ratio threshold Tm1 can be set to any suitable value, such as 5.0 or other suitable value. If the motion magnitude ratio is smaller than a second motion ratio threshold (denoted as Tm2) but greater than the first threshold Tm1, the confidence value can be increased by a second amount (e.g., by 1 or other suitable amount that is less than the first amount). The second motion ratio threshold Tm2 can be set to any suitable value (e.g., 10.0 or other suitable value) that is greater than the first motion ratio threshold Tm1. In some cases, if the motion magnitude ratio of a tracker is larger than a third motion ratio threshold (denoted as Tm3), the confidence value for the tracker is decreased by an amount (e.g., decreased by 2 or other suitable amount). The third motion ratio threshold Tm3 can be set to any suitable value (e.g., 15.0 or other suitable value) that is greater than the first and second motion ratio thresholds Tm1 and Tm2. In some cases, if the motion magnitude ratio for a tracker is between Tm2 and Tm3, the confidence value may not be increased or decreased.

The region magnitude ratio can be referred to as a “relevant region magnitude ratio,” and can be determined by the region magnitude ratio engine 736 by comparing the regions generated by the periodically sampled bounding boxes (at each status duration n*T for new trackers or n*(T/2) for split-new trackers) and the regions generated by all the bounding boxes in the bounding box history of a tracker. The bounding region magnitude ratio can include a union of bounding regions of the blob tracker in at least two key frames divided by a union of bounding regions of the blob tracker in each frame of the bounding box history (between the first previous frame in the history and the current frame). As described above, a key frame is a frame that occurs at every key frame cycle T (e.g., frame 30, frame 60, frame 90, and so on for a key frame cycle of 30).

In one illustrative example of determining the region magnitude ratio, the allRelevantRegionBox denotes the union of all bounding boxes of the tracker in the tracker's bounding box history. The keyFrameRelevantRegionBox denotes as the union of bounding boxes in the key frames. Using such notation, the region magnitude ratio is equal to the size of the union bounding box keyFrameRelevantRegionBox divided by the size of the union bounding box allRelevantRegionBox. Such a calculation is denoted as bbSize(keyFrameRelevantRegionBox)/bb Size(allRelevantRegionBox), with the term bb Size returning the size of an input bounding box.

If the region magnitude ratio is larger than a first bounding region magnitude ratio threshold (denoted as Tr1), the confidence value is increased by a first amount (e.g., by 1 or other suitable amount). The first region magnitude ratio threshold Tr1 can be set to any suitable value, such as 0.7 or other suitable value. If the region magnitude ratio is smaller than a second bounding region magnitude ratio threshold (denoted as Tr2), the confidence value is decreased by a second amount (e.g., 3 or other suitable amount). The second bounding region magnitude ratio threshold can be set to any suitable value (e.g., 0.3 or other suitable value) that is less than the first bounding region magnitude ratio threshold. In some cases, if the region magnitude ratio for a tracker is between Tr1 and Tr2, the confidence value for the tracker may not be increased or decreased.

The region temporal size change can be determined by the region temporal size change engine 738 by to determine the temporal size change of relevant regions of the bounding boxes in a tracker's bounding box history. The relevant regions are defined similarly as described above for the region magnitude ratio. However, for a given current time instance (e.g., n*T or n*(T/2)), not only the relevant regions of the current time instance are used, but also the relevant regions of the previous key frame time instance (e.g., (n−1)T) are used. For example, the region temporal size change can be determined by dividing the size of the bounding box region in the current key frame (the current frame being processed by the true-false positive detection process) by the union of the bounding box region sizes in all bounding boxes in the tracker's bounding box history. This region temporal size change characteristic can be used to accommodate the cases when an object works perpendicular to the image plane of the camera (e.g., a person is walking toward or away from the image plane).

When the temporal size change of relevant regions is larger than a first temporal size change threshold (denoted as Tt1) and is smaller than a second temporal size change threshold (denoted as Tt2), the confidence value is increased by a first amount (e.g., by 3 or other suitable amount). The first temporal size change threshold Tt1 can be set to any suitable value (e.g., 1.5 or other suitable value), and the second temporal size change threshold Tt1 can be set to any suitable value (e.g., set to 3.0 or other suitable value) that is larger than the first temporal size change threshold. When temporal size change of relevant regions is smaller than a third temporal size change threshold (denoted as Tt3), the confidence value is decreased by a second amount (e.g., by 10 or other suitable amount). The third temporal size change threshold Tt3 can be set to any suitable value (e.g., set to 1.03 or other suitable value) that is smaller than the first temporal size change threshold.

In some cases, the true-false positive detection analysis system 730 can determine the final confidence value 739 for the tracker by combining all the above-described characteristics with an initial confidence value of 0.

A detailed illustrative implementation of the true-false positive detection analysis is provided below:

Inputs to the bounding box include the determination of oneCycle, bounding box history (or “history duration”) of N frames and the previous globalBoxSize and the previous keyFrameBoxSize (although N is typically equal to n*T (T denotes an interval of key frames), but the function itself is designed to be generic).

A current frame is a key frame if T % N is equal to 0 and a non-key frame otherwise.

The invocation of such a process typically applies to key frames (with N equal to n*T), however, when lower delay is required, such a process can apply to non-key frames, but with different parameters and modified sub-processes.

Before calculating confidence, we inspect the value of N, if it is smaller than T0, the process returns by not changing the tracker status in the current frame. For example, T0 is set to T/2.

For tracker freezing status checking, the checked frames iComLength at front-end side of the tracker is defined:

```
if the current tracker is a split (new) tracker
  iComLength = T / 6;
else
  iComLength = N / 6;
if (iComLength <= 1)
  iComLength = 2;
for (int i = 0; i< iComLength; i++)
{
  pcBox1 = &pTestTracker->bbox[i].cc;
  pcBox2 = &pTestTracker->bbox[iTestDuration − 1 − i].cc;
  Union(*pcBox1, *pcBox2, bbUnion);
  Intersect(*pcBox1, *pcBox2, bbIntersect);
  if (bbIntersect.rectHeight*bbIntersect.rectWidth >(int)
(bbUnion.rectHeight * bbUnion.rectWidth *0.81))
  {
    return false;
  }
}
```

A variable shorterthanFirstKeyFlag is set to true when the N is between T/2-1 and T, exclusive, and false otherwise.

A variable shorterthanSecondKeyFlag is set to true when the N is less than or equal to 2*T, and false otherwise.

A variable firstCycleKeyFlag is set to true when N is equal to T, and false otherwise. A variable laterCycleKeyFlag is set to true when the current frame is a key frame and N is larger than T, and false otherwise.

For tracker jumping status checking, for simplicity, denote a bounding box array of BBHis and each of it includes not only width, height, topLeftX, topLeftY as attributes, but also the centerX, centerY, fSizeRatio, fVelMagnitude, as additional attributes.

Here fSizeRatio of bounding box BBHis[i] is calculated as BBHis[i+1]/BBHis[i] for i from 0 through N−2, inclusive.

// unify the first key frame and following key frames

Here iNumBigSizeChange and iNumMidSizeChange of neighboring BBHis are calculated as:

```
iNumBigSizeChange = 0;
iNumMidSizeChange = 0;
if(firstCycleKeyFlag || shorterthanFirstKeyFlag)
{
    for (i = 0; i<N−1; i++)
    {
      sizeSmall = MIN(BBHis[i].width*BBHis[i].height,
  BBHis[i+1].width*BBHis[i+1].height);
      sizeBig = MAX(BBHis[i].width*BBHis[i].height,
  BBHis[i+1].width*BBHis[i+1].height);
      if (sizeBig > 2*sizeSmall) iNumBigSizeChange++;
      if (2*sizeBig > 3*sizeSmall) iNumMidSizeChange++;
      if (sizeBig > 2*sizeSmall && 2*sizeBig > 3*sizeSmall)
  iNumMidSizeChange++;
    }
  }
```

Here fVelMagnitude of bounding box BBHis[i] is calculated as:

sqrt((BBHis[i+1]·centerX−BBHis[i]·centerX)*(BBHis[i+1]·centerX−BBHis[i]·centerX)+(BBHis[i+1]·centerY−BBHis[i]·centerY)*(BBHis[i+1]·centerY−BBHis[i]·centerY))

Variable sumVelMag is initiated to be 0.

```
for (i = 0; i<N−1; i++)
{
  if (BBHis[i].fSizeRatio> 0.5 || BBHis[i].fSizeRatio<−0.33)
  iSizeJump++;
  else
  {
      iGoodSizeCnt++;
      iSizeSum +=
      pTestTracker->sNewTrackerProStatus.hisBoxInfo[i].iBoxSize;
      iWidthSum +=
      pTestTracker->sNewTrackerProStatus.hisBoxInfo[i].iBoxWidth;
      iHeightSum+=
      pTestTracker->sNewTrackerProStatus.hisBoxInfo[i].iBoxHeight;
    }
    sumVelMag+=BBHis[i]. fVelMagnitude;
  }
avgWidth = iWidthSum / iGoodSizeCnt;
avgHeight= iHeightSum/ iGoodSizeCnt;
globalMoveX= BBHis[N − 1]. centerX − BBHis[0]. centerX;
globalMoveY= BBHis[N − 1]. centerY − BBHis[0]. centerY;
```

Full-body motion iFinalFullBodyMoveCounter is calculated as follows:

iFinalFullBodyMoveCounter=Max(abs(globalMoveX)/avgWidth,abs(globalMoveY)/avgHeight)

Motion magnitude ratio fFinalMotionMagnitudeRatio is calculated as follows:

globalMagnitude=sqrt(globalMoveX*globalMoveX+globalMoveY*globalMoveY);

fFinalMotionMagnitudeRatio=sumVelMag/globalMagnitude;

Define two bounding boxes globalBox and keyFrameBox, both are initiated as empty.

iContLarge is set to 3.

When shorterthanSecondKeyFlag is false, a variable iContLarge is set to N/T;

```
for (i = 0 && iContLarge>=0; i<N; i++)
{
  globalBox = Union(globalBox, BBHis[i];
  bIntermediateCheckedFrame = (N<60 ? (N<=30: i==N/3: I == N/2):
  i== (N%T));
  if (bIntermediateCheckedFrame )
  {
    globalBoxSize = bbSize(globalBox);
    keyFrameBox = Union(keyFrameBox, BBHis[i]);
    keyFrameBoxSize = bbSize(keyFrameBox);
    if (!shorterthanSecondKeyFlag)
      iContLarge−−;
  }
}
fFinalGlobalSizeRatio = bbSize(keyFrameBox) / bbSize(globalBox);
iCurSizeGlobalBox = bbSize(globalBox);
iCurSizeKeyFrameBox = bbSize(keyFrameBox);
fRangeChangeRatio1 = iCurSizeGlobalBox / globalBoxSize;
fRangeChangeRatio2 = iCurSizeKeyFrameBox / keyFrameBoxSize;
fRangeChangeRatioMin =
MIN(fRangeChangeRatio1,fRangeChangeRatio2);
fRangeChangeRatioMax =
MAX(fRangeChangeRatio1,fRangeChangeRatio2);
```

iPreSampingFrame is set to be the duration when the previous true/false positive detection function is called for the current tracker.

iCurFrame is set to be the duration when the current true/false positive detection function is called, which is equan to N.

```
fRangeChangeRatioPick = fRangeChangeRatioMin*
(((iPreSampingFrame * 2 − 4) > iCurFrame ? 1.2 : 1.0));
magRatioThresholdLevel1 = firstCycleKeyFlag ? 3.27 : 5.0;
magRatioThresholdLeve12 = firstCycleKeyFlag? 3.9 : 10.1;
globalSizeRatioThreshold = firstCycleKeyFlag? 0.95 ? 0.7;
magRatioVal = firstCycleKeyFlag? 1: 2;
The parameter iFinalFullBodyMoveCounter is set as follows
middlePoint = T*2/3;
if (N <= middlePoint)
{
  iConfLevel += (iFinalFullBodyMoveCounter >= 2 ? 1 : 0);
  iConfLevel += (iFinalFullBodyMoveCounter >= 1 ? 0 : 0);
}
else
{
  iConfLevel += (iFinalFullBodyMoveCounter >= 2 ? 10 : 0);
  iConfLevel += (iFinalFullBodyMoveCounter >= 1 ? 3 : 0);
}
```

The parameters fFinalMotionMagnitudeRatio, fRangeChangeRatioMax, iNumBigSizeChange and iNumMidSizeChange are set as functions, according to the value of N and three intervals defined by 15, 17, 20 and 30.

Simple interpolation function ƒ(x|a, b, vₐ, v_{b}) is defined as follows:

$$f ( x \vert a , b , {v}_{a} , {v}_{b} ) = \frac{x - a}{b - a} ( {v}_{b} - {v}_{a} ) + {v}_{a}$$

$$segments [ 4 ] = \{ 15 , 17 , 20 , 30 \} ;$$

The iConfLevel is calculated as follows:

```
iConfLevel =0;
if (fGlobalMotionMagnitude == 0)
{
  fFinalMotionMagnitudeRatio = 16;
  iConfLevel −= 10;
}
else if (ShorterthanFirstKeyFlag)
{
  motionSegV1[4] = { 1.0, 1.16, 1.16, 3.27 };
  motionSegV2[4] = { 1.34, 1.85, 1.45, 3.9 };
  motionV1 =f(N|segments[idxLeft], segments[idxRight],
motionSeg1[idxLeft], motionSeg1[idxRight]);
  motionV2 =f(N|segments[idxLeft], segments[idxRight],
motionSeg2[idxLeft], motionSeg2[idxRight]);
  iConfLevel += (fFinalMotionMagnitudeRatio < motionV1 ? 1 : 0);
  iConfLevel += (fFinalMotionMagnitudeRatio < motionV2 ? 1 : 0);
}
else if (firstCycleKeyFlag)
{
  if (!outdoorMode)
    iConfLevel += (fFinalMotionMagnitudeRatio < 1.0 ? 1 : 0);
  else
  {
    iConfLevel += (fFinalMotionMagnitudeRatio <
    magRatioThresholdLevel1 ? 1 : 0);
    iConfLevel += (fFinalMotionMagnitudeRatio <
    magRatioThresholdLevel2 ? 1 : 0);
  }
}
else if (!laterCycleKeyFlag)
{
  iConfLevel += (fFinalMotionMagnitudeRatio < 3.67 ? 2 : 0);
  iConfLevel += (fFinalMotionMagnitudeRatio < 4.02 ? 1 : 0);
}
else
{
  iConfLevel += (fFinalMotionMagnitudeRatio < 5.0 ? 2 : 0);
  iConfLevel += (fFinalMotionMagnitudeRatio < 10.1 ? 1 : 0);
}
iConfLevel += (fFinalMotionMagnitudeRatio> 15.0 ? −2 : 0);
if (ShorterthanFirstKeyFlag)
{
  rangeSegV1[4] = { 1.02, 1.29, 1.14, 1.03 };
  rangeSegV2[4] = { −2, −3, −6, −10 };
  rangeV1 =f(N|segments[idxLeft], segments[idxRight],
rangeSegV1[idxLeft], rangeSegV1[idxRight]);
  rangeV2 =f(N|segments[idxLeft], segments[idxRight],
rangeSegV2[idxLeft], rangeSegV2[idxRight]);
  iConfLevel += (fRangeChangeRatioMax< rangeV1 ? rangeV2 : 0);
}
else if (the current frame is a key frame)
  iConfLevel += (fRangeChangeRatioMax< 1.03 ? −10: 0);
else
  iConfLevel += (fRangeChangeRatioMax < 1.08 ? −10 : 0);
if (ShorterthanFirstKeyFlag)
{
  sizeChangeV1[4] = { 2, 2, 2, 3 };
  sizeChangeV2[4] = { 3, 3, 3, 6 };
  sizeChangeV3[4] = { 4, 4, 4, 5 };
  sizeV1 =f(N|segments[idxLeft], segments[idxRight],
sizeChangeV1[idxLeft], sizeChangeV1[idxRight]);
  sizeV2 =f(N|segments[idxLeft], segments[idxRight],
sizeChangeV2[idxLeft], sizeChangeV2[idxRight]);
  sizeV3 =f(N|segments[idxLeft], segments[idxRight],
sizeChangeV3[idxLeft], sizeChangeV3[idxRight]);
  if (iNumBigSizeChange >= sizeV1 || iNumMidSizeChange >= sizeV2)
    iConfLevel −= sizeV3;
}
else if (firstCycleKeyFlag)
{
  if (iNumBigSizeChange >= 3 || iNumMidSizeChange >= 6)
  {
    iConfLevel −= 5;
  }
}
if (firstCycleKeyFlag || ShorterthanFirstKeyFlag)
  iConfLevel += (fFinalGlobalSizeRatio> 0.95 ? 1 : 0);
else
  iConfLevel += (fFinalGlobalSizeRatio > 0.7 ? 1 : 0);
iConfLevel += (fFinalGlobalSizeRatio< 0.5 ? −3 : 0);
if (!firstCycleKeyFlag && !ShorterthanFirstKeyFlag)
{
  if (!outdoorMode)
  iConfLevel += (fRangeChangeRatioPick > 1.7 &&
fRangeChangeRatioPick < 3.0 ? 3 : 0);
  else
  iConfLevel += (fRangeChangeRatioPick>1.5 &&
fRangeChangeRatioPick<3.0 ? 3 : 0);
}
```

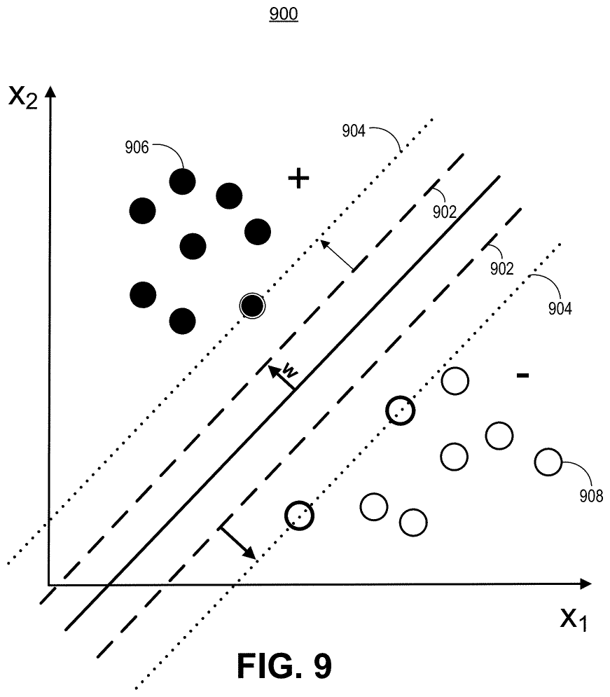

Using the true-false positive detection process described above, the chance of a false positive and a true positive output is increased in some cases. In order to get more true positive results and less false positive results, the true and false positive output conditions can be changed so that they are more stringent, as illustrated in the graph 900 shown in FIG. 9. As shown, the false positive removal margin of previous false positive detection techniques is between the two dashed lines (indicated in FIG. 9 by the two dashed lines 902), but can be enlarged to the two dotted lines (indicated in FIG. 9 by the two dotted lines 904) to make the true and false positive output conditions stricter. As indicated by the “+” sign in FIG. 9, the full circles (e.g., circle 906) correspond to true positive blobs or objects associated with trackers that should be output. As indicated by the “−” sign in FIG. 9, the empty circles (e.g., circle 908) correspond to false positive blobs or objects associated with trackers that should not be output. Trackers corresponding to circles that are outside of the boundary (of the two dotted lines 904 or the two dashed lines 902) are output as true positives (when on the plus side of the boundary) or false positives (when on the negative side of the boundary), while trackers corresponding to circles that fall between the boundary can be assigned the intermediate status and maintained for further analysis (e.g., by the sub-process 600A and/or the sub-process 600B). The strict false positive removal scheme can be made more sensitive for different use cases. To comply with the false positive removal scheme, different tuned false positive determination parameters can be used.

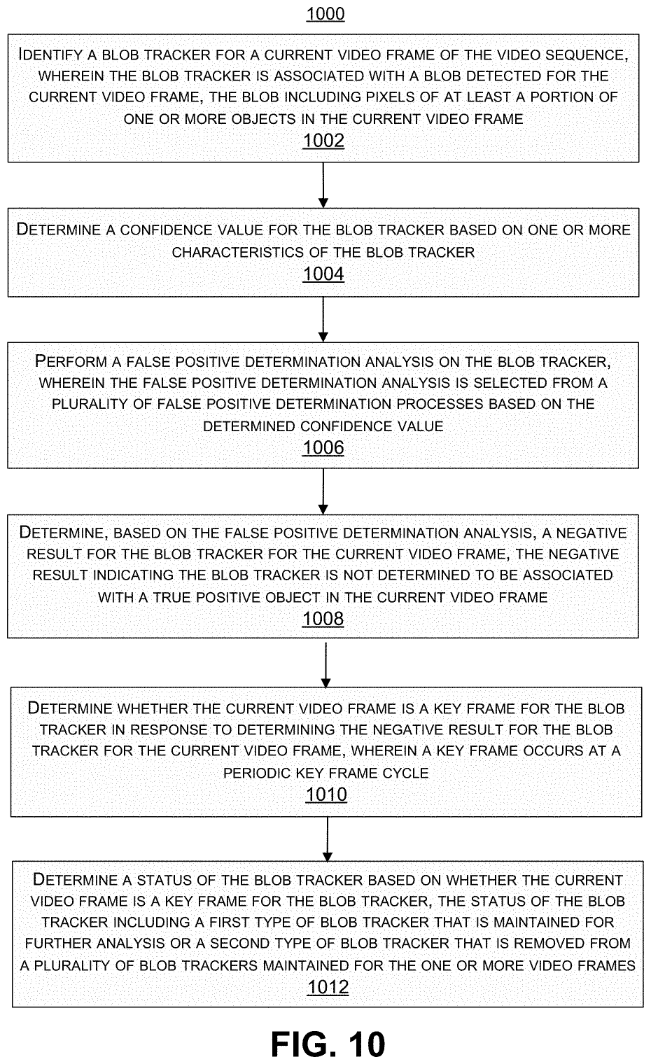

FIG. 10 is a flowchart illustrating an example of a process 1000 of maintaining blob trackers for one or more video frames of a video sequence using the techniques described herein. At block 1002, the process 1000 includes identifying a blob tracker for a current video frame of the video sequence. The blob tracker is associated with a blob detected for the current video frame. The blob includes pixels of at least a portion of one or more objects in the current video frame.

At block 1004, the process 1000 includes determining a confidence value for the blob tracker based on one or more characteristics of the blob tracker. In some cases, a confidence value is periodically determined for the blob tracker at every detection frame of the video sequence. A detection frame occurs at a pre-defined duration that is less than the periodic key frame cycle.

In some implementations, the process 1000 can include determining the one or more characteristics of the blob tracker based on a bounding region history of the blob tracker. The bounding region history can include one or more locations of bounding regions of the blob tracker in one or more previous video frames occurring prior to the current video frame in the video sequence. In some examples, the process 1000 can determine the one or more characteristics of the blob tracker by determining a motion characteristic of the blob tracker. As described above, the motion characteristic can include a movement of a bounding region of the blob tracker from a previous location in a previous video frame to a current location in the current video frame. The motion characteristic of the blob tracker can be determined by determining an average width and an average height of the bounding region of the blob tracker from the previous video frame to the current video frame, determining an amount of movement of the bounding region from the previous location to the current location in a horizontal direction, and determining an amount of movement of the bounding region from the previous location to the current location in a vertical direction. The motion characteristic can then be determined based on the determined average width, the determined amount of movement in the horizontal direction, and the determined amount of movement in the vertical direction, as described above. In some cases, the motion characteristic can be determined as a maximum value from among the amount of movement of the bounding region in the horizontal direction divided by the average width and the amount of movement of the bounding region in the vertical direction divided by the average height.

In some examples, determining the confidence value for the blob tracker based on the one or more characteristics can include increasing the confidence value for the blob tracker by a first amount when the motion characteristic of the blob tracker is greater than a first motion characteristic threshold. In some examples, determining the confidence value for the blob tracker based on the one or more characteristics can include increasing the confidence value for the blob tracker by a second amount when the motion characteristic of the blob tracker is greater than a second motion characteristic threshold. In such examples, the second amount is less than the first amount, and the second motion characteristic threshold is less than the first motion characteristic threshold.

In some examples, the one or more characteristics of the blob tracker can be determined by determining a motion magnitude ratio of the blob tracker. As described above, the motion magnitude ratio includes an accumulated motion of a bounding region of the blob tracker between consecutive video frames divided by a global motion of the bounding region. The global motion includes motion of the bounding region from a previous location in a previous video frame to a current location in the current video frame. In some cases, the accumulated motion includes a sum of motion of the bounding region between each frame pair between the previous video frame and the current video frame.

In some examples, the confidence value for the blob tracker can be determined based on the one or more characteristics by increasing the confidence value for the blob tracker by a first amount when the motion magnitude ratio of the blob tracker is less than a first motion ratio threshold. In some examples, the confidence value for the blob tracker can be determined based on the one or more characteristics by increasing the confidence value for the blob tracker by a second amount when the motion magnitude ratio of the blob tracker is less than a second motion ratio threshold. In such examples, the second amount is less than the first amount, and the second motion ratio threshold is greater than the first motion ratio threshold.

In some examples, the one or more characteristics of the blob tracker can be determined by determining a bounding region magnitude ratio of the blob tracker. As described above, the bounding region magnitude ratio includes a union of bounding regions of the blob tracker in at least two key frames divided by a union of bounding regions of the blob tracker in each frame between a previous video frame and the current video frame. As described herein, a key frame occurs at a periodic key frame cycle, and in some cases, can be aligned with a duration used for determining the status of the blob tracker (e.g., aligned with a threshold duration).

In some examples, the confidence value for the blob tracker can be determined based on the one or more characteristics by increasing the confidence value for the blob tracker by a first amount when the bounding region magnitude ratio of the blob tracker is greater than a first bounding region magnitude ratio threshold. In some examples, the confidence value for the blob tracker can be determined based on the one or more characteristics by decreasing the confidence value for the blob tracker by a second amount when the bounding region magnitude ratio of the blob tracker is less than a second bounding region magnitude ratio threshold. In such examples, the second bounding region magnitude ratio threshold is less than the first bounding region magnitude threshold.

In some examples, the one or more characteristics of the blob tracker can be determined by determining a temporal size change of the blob tracker. As described above, the temporal size change includes a size of a bounding region of the blob tracker in the current frame divided by a union of bounding regions of the blob tracker in each frame between a previous video frame and the current video frame. In such an example, the current frame is aligned with a duration (e.g., a threshold duration) used for determining the status of the blob tracker.

In some examples, the confidence value for the blob tracker can be determined based on the one or more characteristics by increasing the confidence value for the blob tracker by a first amount when the temporal size change of the blob tracker is between a first temporal size change threshold and a second temporal size change threshold. In some examples, the confidence value for the blob tracker can be determined based on the one or more characteristics by decreasing the confidence value for the blob tracker by a second amount when the temporal size change of the blob tracker is less than a third temporal size change threshold. In such examples, the third temporal size change threshold is less than the first temporal size change threshold and the second temporal size change threshold.

At block 1006, the process 1000 includes performing a false positive determination analysis on the blob tracker. The false positive determination analysis is selected from a plurality of false positive determination processes based on the determined confidence value. At block 1008, the process 1000 includes determining, based on the false positive determination analysis, a negative result for the blob tracker for the current video frame. The negative result indicates the blob tracker is not determined to be associated with a true positive object in the current video frame.

In some examples, the false positive determination analysis is performed when the confidence value is determined to be less than a third confidence threshold. A first confidence threshold is greater than a second confidence threshold and the third confidence threshold, and the second confidence threshold is greater than the third confidence threshold. Referring to FIG. 6B as an example, the first confidence threshold can be the threshold TC1, the second confidence threshold can be the threshold TC2, and the third confidence threshold can be the threshold TC3.

The false positive determination analysis performed when the confidence value is less than a third confidence threshold can include the AMFR process described above. For example, performing the false positive determination analysis can include determining a current characteristic of pixels in a region of the current video frame associated with the blob tracker, determining a previous characteristic of pixels in a region of a previous video frame associated with the blob tracker, and determining a difference between the current characteristic and the previous characteristic. The negative result is determined (at block 1008) for the blob tracker when the difference between the current characteristic and the previous characteristic is less than a threshold difference.

In some examples, a first type of pixel analysis from the plurality of false positive determination processes is performed when the confidence value is determined to be less than the second confidence threshold (e.g., threshold TC2). The first type of pixel analysis can include the strong pixel level analysis (described above with respect to FIG. 6B). A second type of pixel analysis from the plurality of false positive determination processes is performed when the confidence value is determined to be greater than the second confidence threshold (e.g., threshold TC2). The second type of pixel analysis can include the lightweight pixel level analysis (described above with respect to FIG. 6B).

At block 1010, the process 1000 includes determining whether the current video frame is a key frame for the blob tracker in response to determining the negative result for the blob tracker for the current video frame. A key frame occurs at a periodic key frame cycle. At block 1012, the process 1000 includes determining a status of the blob tracker based on whether the current video frame is a key frame for the blob tracker. The status of the blob tracker includes a first type of blob tracker that is maintained for further analysis or a second type of blob tracker that is removed from a plurality of blob trackers maintained for the one or more video frames.

In some cases, the process 1000 can determine that the blob tracker is the second type of tracker when the current video frame is determined to be a key frame for the blob tracker. The process 1000 can remove the blob tracker from the plurality of blob trackers maintained for the one or more video frames in response to determining that the blob tracker is the second type of tracker.

In some examples, the process 1000 can determine that the blob tracker is the first type of blob tracker when the current video frame is determined not to be a key frame for the blob tracker.

In some examples, the process 1000 can determine a history duration of the blob tracker for a subsequent video frame occurring after the current video frame in the video sequence. The history duration can be denoted as N. as described above, the history duration (N) indicates a number of video frames since creation of the blob tracker. The process 1000 can determine, for the subsequent video frame, whether the history duration of the blob tracker is less than a short-term cycle threshold. The short-term cycle threshold includes one or more periodic key frame cycles. For example, the short-term cycle threshold can include one key frame cycle, in which case block 601 of the sub-process 600A (shown in FIG. 6A) can be performed to determine whether it is a first key frame cycle for the blob tracker. The process 1000 can determine whether the blob tracker is a first type of false positive tracker or a second type of false positive tracker when the history duration of the blob tracker is less than the short-term cycle threshold. The first type of false positive tracker is referred to herein as a freeze or frozen tracker. As described herein, the first type of false positive tracker has a first bounding box and a second bounding box with an overlapping ratio greater than an alignment threshold for the first type of false positive tracker. The second type of false positive tracker is referred to herein as a jumping tracker. As described herein, the second type of false positive tracker has an irregular size change or an irregular motion change over a periodic key frame cycle.

In some cases, the process 1000 can maintain the blob tracker for the one or more video frames when the blob tracker is the first type of false positive tracker or the second type of false positive tracker. In some cases, the process 1000 can determine a confidence value for the blob tracker based on one or more characteristics of the blob tracker determined for the subsequent video frame.

In some examples, the overlapping ratio related to the first type of false positive tracker includes a ratio of an intersection and a union of a first bounding box of the blob tracker in a previous video frame and a second bounding box of the blob tracker in the subsequent video frame. In some cases, the process 1000 can determine whether the blob tracker is the first type of false positive tracker (e.g., a frozen tracker) by determining an alignment threshold for the blob tracker, determining the overlapping ratio of the first bounding box and the second bounding box of the blob tracker, and comparing the overlapping ratio of the blob tracker to the alignment threshold. The blob tracker is determined to be the first type of false positive tracker when the overlapping ratio is greater than the alignment threshold. In some aspects, the alignment threshold for the blob tracker is based on a size of the first bounding box or the second bounding box of the blob tracker. In some examples, the blob tracker is determined to be the first type of false positive tracker when overlapping ratios of the blob tracker are greater than the alignment threshold for a threshold number of frames.

In some cases, the process 1000 can determine whether the blob tracker is the second type of false positive tracker (e.g., a jumping tracker) based on a number of irregular size changes of the blob tracker. For example, the process 1000 can determine a number of irregular size changes of the blob tracker within the periodic key frame cycle. As described above, an irregular size change includes a change in size of the blob tracker between a previous video frame and the subsequent video frame greater than a size change threshold. The process 1000 can compare the number of irregular size changes of the blob tracker to a threshold number of irregular size changes, and can determine that the blob tracker is the second type of false positive tracker when the number of irregular size changes of the blob tracker is greater than the threshold number of irregular size changes.

In some cases, the process 1000 can determine whether the blob tracker is the second type of false positive tracker (e.g., a jumping tracker) based on an irregular motion change of the blob tracker that includes a motion direction consistency of the blob tracker. For example, the process 1000 can determine an irregular motion change of the blob tracker, where the irregular motion change includes a motion direction consistency of the blob tracker. The motion direction consistency is based on velocities of the blob tracker between consecutive frames. The process 1000 can compare the motion direction consistency of the blob tracker to a motion direction threshold, and can determine that the blob tracker is the second type of false positive tracker when the motion direction consistency of the blob tracker is less than the motion direction threshold.

In some cases, the process 1000 can determine whether the blob tracker is the second type of false positive tracker (e.g., a jumping tracker) based on an irregular motion change of the blob tracker that includes a motion magnitude of the blob tracker. For example, the process 1000 can determine an irregular motion change of the blob tracker, where the irregular motion change includes a motion magnitude of the blob tracker. The motion magnitude includes a magnitude of velocities of the blob tracker over the periodic key frame cycle. The process 1000 can compare the motion magnitude of the blob tracker to a motion magnitude threshold, and can determine the blob tracker is the second type of false positive tracker when the motion magnitude of the blob tracker is greater than the motion magnitude threshold.

In some examples, the status of the blob tracker is determined to be of a third type of blob tracker when the confidence value is determined to be greater than a first confidence threshold. A blob tracker of the third type is output as an identified blob tracker-blob pair, and is referred to as a normal tracker herein.

In some examples, the process 1000 may be performed by a computing device or an apparatus, such as a video analytics system. In some cases, the computing device or apparatus may include a processor, microprocessor, microcomputer, or other component of a device that is configured to carry out the steps of process 1000. In some examples, the computing device or apparatus may include a camera configured to capture video data (e.g., a video sequence) including video frames. For example, the computing device may include a camera device (e.g., an IP camera or other type of camera device) that may include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other image capture device that captures the video data is separate from the computing device, in which case the computing device receives the captured video data. The computing device may further include a network interface configured to communicate the video data. The network interface may be configured to communicate Internet Protocol (IP) based data.

Process 1000 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The true-false positive detection systems and methods described herein reduce the object detection and tracking latency in video analytics, and can improve the true positive detection rate and reduce the false positive detection as well.

Various test conditions are described below and objective simulation results are shown in Table 1 in order to illustrate results of the techniques discussed herein. Simulations were conducted on 53 video clips, where 34 VIRAT video clips were used for professional security cases, and 19 video clips are home security cases. Both cases range from easy to difficult video clips. The objective results (shown in Table 1) are measured using the recall rate, false positive rate, average tracking delay and maximal tracking delay in “VAM” report.

TABLE 1

| | | | Average | Maximal |
|---|---|---|---|---|
| | Recall | False positive | tracking | tracking |
| Method | rate (%) | rate (%) | delay (sec) | delay (sec) |
| Anchor | 89.49 | 4.79 | 3.71 | 8.41 |
| Proposed | 92.92 | 3.06 | 2.23 | 6.78 |

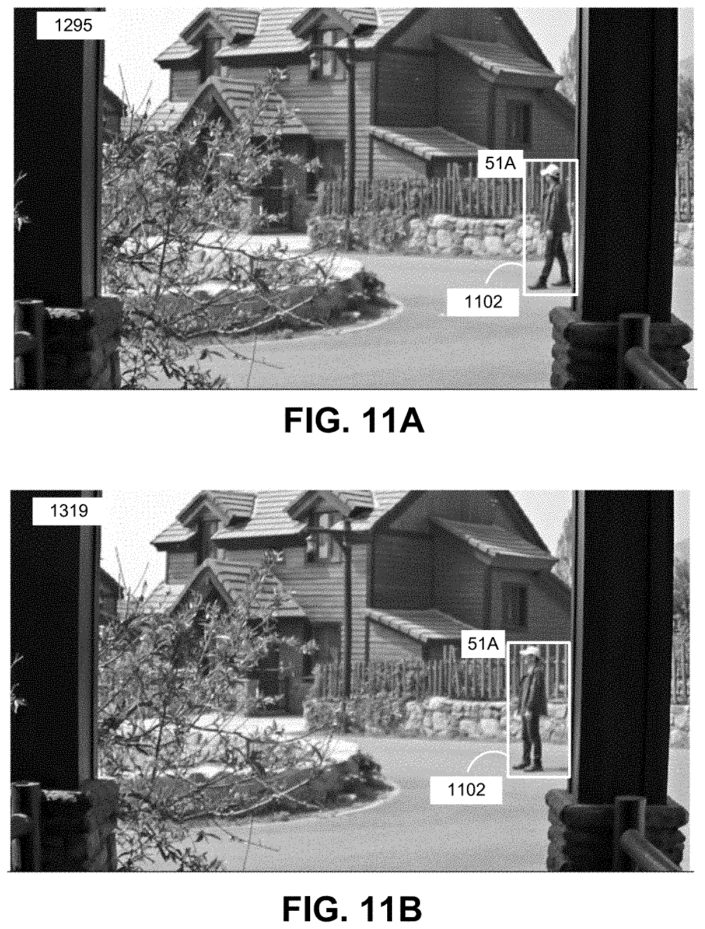

Subjective results of the techniques discussed herein are described below with respect to FIG. 11-FIG. 16. Results of both methods are shown in bounding boxes with different tracker IDs—the tracker IDs ending in “A” result from using the techniques discussed herein and the tracker IDs ending in “B” result from using the anchor method. Tracker bounding boxes with two tracker IDs (one ending in “A” and the other ending in “B”) indicate that there are two identical overlapping bounding boxes, one output using the techniques discussed herein and one output using the anchor method.

As shown in FIG. 11A (frame 1295) and FIG. 11B (frame 1319), for frame 1295 through frame 1319, the proposed method tracks the object (label 51A) using bounding box 1102 while the anchor method does not.

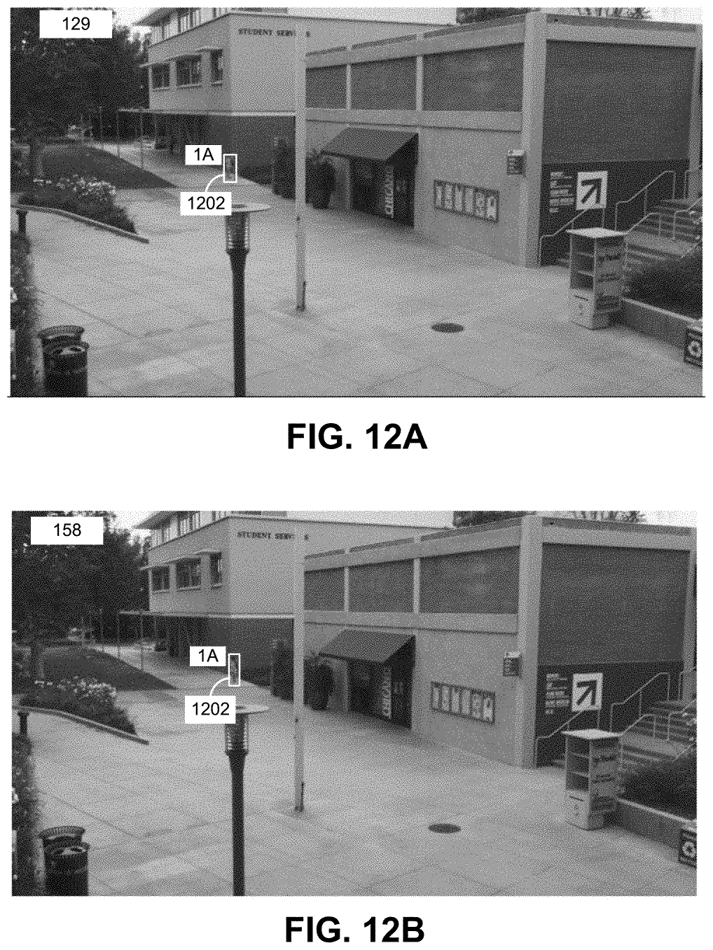

As shown in FIG. 12A (frame 129) and FIG. 12B (frame 158), for frame 129 through frame 158, the proposed method tracks the object (label 1A) using bounding box 1202 while the anchor method does not.

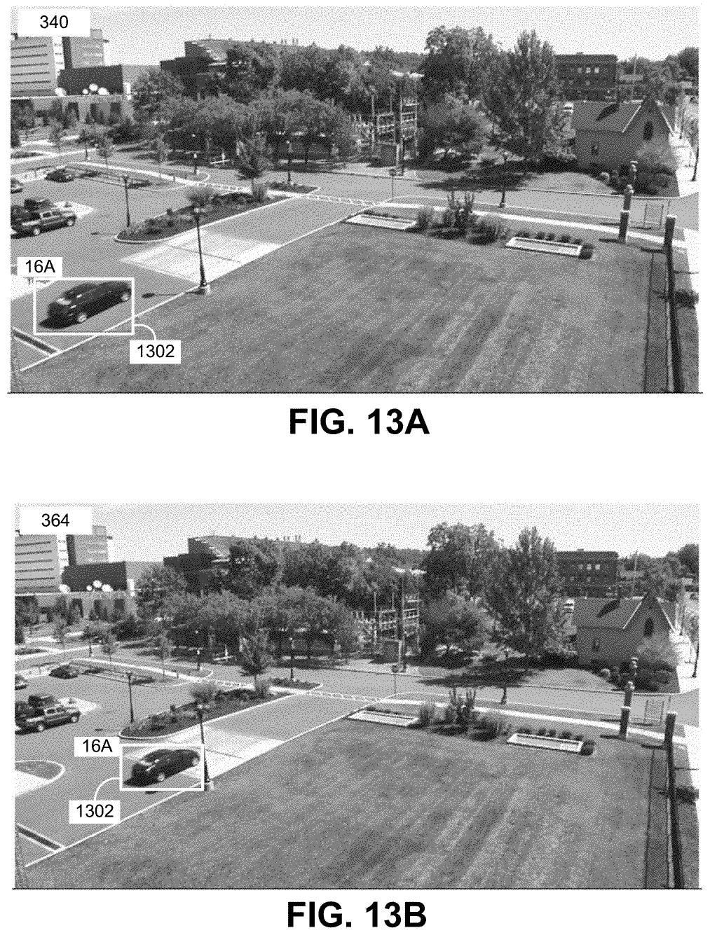

As shown in FIG. 13A (frame 340) and FIG. 13B (frame 364), for frame 340 through frame 364, the proposed method tracks the object (label 16A) using bounding box 1302 while the anchor method does not.

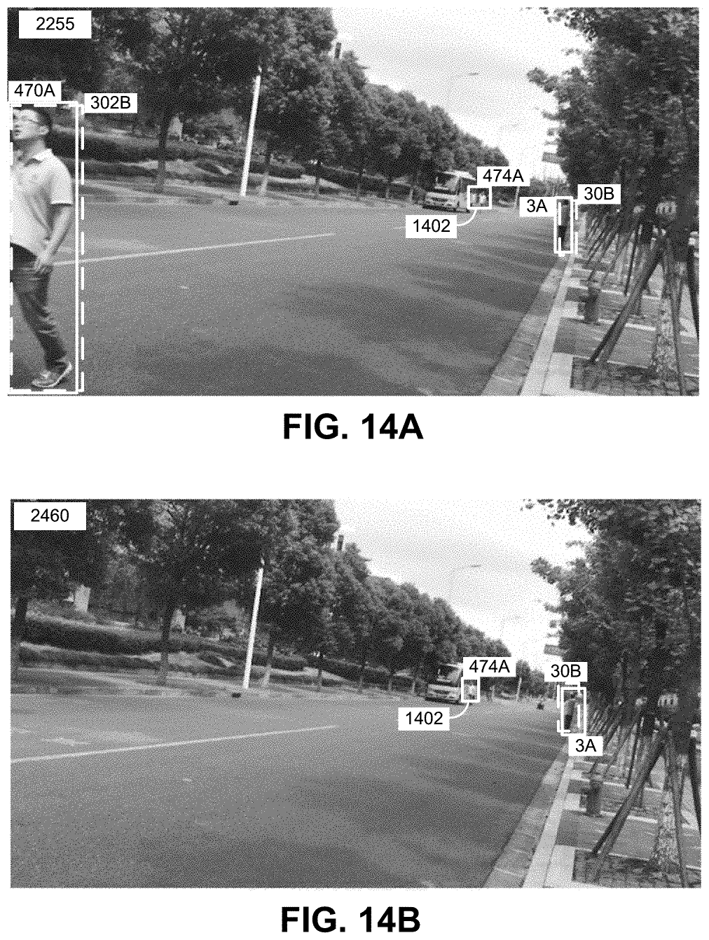

As shown in FIG. 14A (frame 2255) and FIG. 14B (frame 2460), for frame 2255 through frame 2460, the proposed method tracks the object (label 474A) using bounding box 1402 while the anchor method does not.

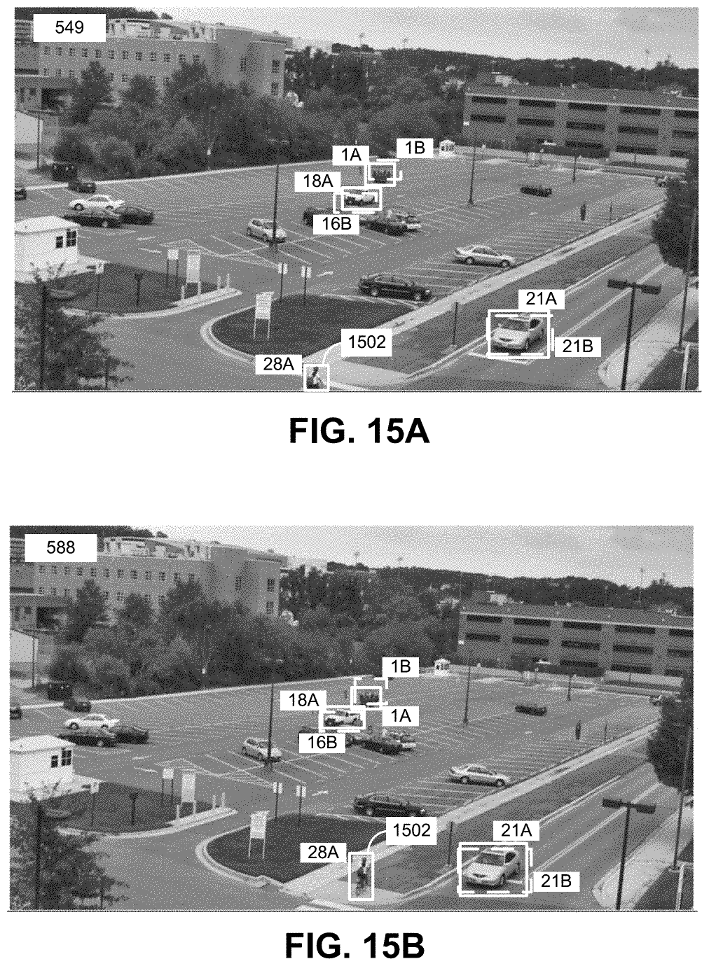

As shown in FIG. 15A (frame 549) and FIG. 15B (frame 588), for frame 549 through frame 588, the proposed method tracks the object (label 28A) using bounding box 1502 while the anchor method does not.

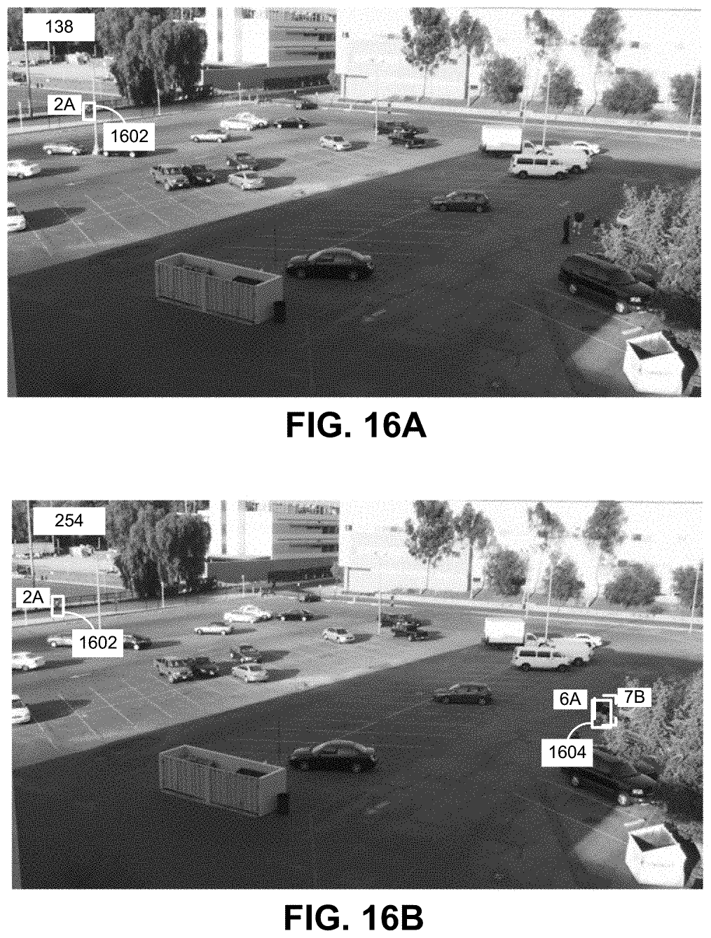

As shown in FIG. 16A (frame 138) and FIG. 16B (frame 254), for frame 138 through frame 254, the proposed method tracks the object (with label 2A) using bounding box 1602 while the anchor method does not. The proposed method and the anchor method track the object with label 6A (for the proposed method) using bounding box 1604 and label 7B (for the anchor method).

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of maintaining blob trackers for one or more video frames of a video sequence, the method comprising:
identifying a blob tracker for a current video frame of the video sequence, wherein the blob tracker is associated with a blob detected for the current video frame, the blob including pixels of at least a portion of one or more objects in the current video frame;
determining a confidence value for the blob tracker based on one or more characteristics of the blob tracker;
performing a false positive determination analysis on the blob tracker, wherein the false positive determination analysis is selected from a plurality of false positive determination processes based on the determined confidence value;
determining, based on the false positive determination analysis, a negative result for the blob tracker for the current video frame, the negative result indicating the blob tracker is not determined to be associated with a true positive object in the current video frame;
determining whether the current video frame is a key frame for the blob tracker in response to determining the negative result for the blob tracker for the current video frame, wherein a key frame occurs at a periodic key frame cycle; and
determining a status of the blob tracker based on whether the current video frame is a key frame for the blob tracker, the status of the blob tracker including a first type of blob tracker that is maintained for further analysis or a second type of blob tracker that is removed from a plurality of blob trackers maintained for the one or more video frames.

2. The method of claim 1, further comprising:
determining the blob tracker as the second type of blob tracker when the current video frame is determined to be a key frame for the blob tracker; and
removing the blob tracker from the plurality of blob trackers maintained for the one or more video frames.

3. The method of claim 1, further comprising determining the blob tracker is the first type of blob tracker when the current video frame is determined not to be a key frame for the blob tracker.

4. The method of claim 1, further comprising:
determining a history duration of the blob tracker for a subsequent video frame occurring after the current video frame in the video sequence, the history duration indicating a number of video frames since creation of the blob tracker;
determining, for the subsequent video frame, whether the history duration of the blob tracker is less than a short-term cycle threshold, the short-term cycle threshold including one or more periodic key frame cycles; and
determining whether the blob tracker is a first type of false positive tracker or a second type of false positive tracker when the history duration of the blob tracker is less than the short-term cycle threshold, wherein the first type of false positive tracker has a first bounding box and a second bounding box with an overlapping ratio greater than an alignment threshold for the first type of false positive tracker, and wherein the second type of false positive tracker has an irregular size change or an irregular motion change over a periodic key frame cycle.

5. The method of claim 4, further comprising maintaining the blob tracker for the one or more video frames when the blob tracker is the first type of false positive tracker or the second type of false positive tracker.

6. The method of claim 4, further comprising determining a confidence value for the blob tracker based on one or more characteristics of the blob tracker determined for the subsequent video frame.

7. The method of claim 4, wherein the overlapping ratio includes a ratio of an intersection and a union of a first bounding box of the blob tracker in a previous video frame and a second bounding box of the blob tracker in the subsequent video frame.

8. The method of claim 7, wherein determining whether the blob tracker is the first type of false positive tracker comprises:
determining an alignment threshold for the blob tracker;
determining the overlapping ratio of the first bounding box and the second bounding box of the blob tracker;
comparing the overlapping ratio of the blob tracker to the alignment threshold; and
determining the blob tracker is the first type of false positive tracker when the overlapping ratio is greater than the alignment threshold.

9. The method of claim 8, wherein the alignment threshold for the blob tracker is based on a size of the first bounding box or the second bounding box of the blob tracker.

10. The method of claim 8, wherein the blob tracker is determined to be the first type of false positive tracker when overlapping ratios of the blob tracker are greater than the alignment threshold for a threshold number of frames.

11. The method of claim 4, wherein determining whether the blob tracker is the second type of false positive tracker comprises:
determining a number of irregular size changes of the blob tracker within the periodic key frame cycle, wherein an irregular size change includes a change in size of the blob tracker between a previous video frame and the subsequent video frame greater than a size change threshold;
comparing the number of irregular size changes of the blob tracker to a threshold number of irregular size changes; and
determining the blob tracker is the second type of false positive tracker when the number of irregular size changes of the blob tracker is greater than the threshold number of irregular size changes.

12. The method of claim 4, wherein determining whether the blob tracker is the second type of false positive tracker comprises:
determining an irregular motion change of the blob tracker, the irregular motion change including a motion direction consistency of the blob tracker, wherein the motion direction consistency is based on velocities of the blob tracker between consecutive frames;
comparing the motion direction consistency of the blob tracker to a motion direction threshold; and
determining the blob tracker is the second type of false positive tracker when the motion direction consistency of the blob tracker is less than the motion direction threshold.

13. The method of claim 4, wherein determining whether the blob tracker is the second type of false positive tracker further comprises:
determining an irregular motion change of the blob tracker, the irregular motion change including a motion magnitude of the blob tracker, wherein the motion magnitude includes a magnitude of velocities of the blob tracker over the periodic key frame cycle;
comparing the motion magnitude of the blob tracker to a motion magnitude threshold; and
determining the blob tracker is the second type of false positive tracker when the motion magnitude of the blob tracker is greater than the motion magnitude threshold.

14. The method of claim 1, wherein a confidence value is periodically determined for the blob tracker at every detection frame of the video sequence, wherein a detection frame occurs at a pre-defined duration that is less than the periodic key frame cycle.

15. The method of claim 1, wherein the status of the blob tracker is determined to be a third type of blob tracker when the confidence value is determined to be greater than a first confidence threshold, wherein a blob tracker of the third type is output as an identified blob tracker-blob pair.

16. The method of claim 1, wherein the false positive determination analysis is performed when the confidence value is determined to be less than a third confidence threshold, wherein a first confidence threshold is greater than a second confidence threshold and the third confidence threshold, and wherein the second confidence threshold is greater than the third confidence threshold.

17. The method of claim 1, wherein performing the false positive determination analysis includes
determining a current characteristic of pixels in a region of the current video frame associated with the blob tracker;
determining a previous characteristic of pixels in a region of a previous video frame associated with the blob tracker; and
determining a difference between the current characteristic and the previous characteristic.

18. The method of claim 17, wherein the negative result is determined for the blob tracker when the difference between the current characteristic and the previous characteristic is less than a threshold difference.

19. The method of claim 1, further comprising determining the one or more characteristics of the blob tracker based on a bounding region history of the blob tracker, the bounding region history including one or more locations of bounding regions of the blob tracker in one or more previous video frames occurring prior to the current video frame in the video sequence.

20. The method of claim 19, wherein determining the one or more characteristics of the blob tracker includes:
determining a motion characteristic of the blob tracker, the motion characteristic including a movement of a bounding region of the blob tracker from a previous location in a previous video frame to a current location in the current video frame.

21. The method of claim 19, wherein determining the one or more characteristics of the blob tracker includes:
determining a motion magnitude ratio of the blob tracker, the motion magnitude ratio including an accumulated motion of a bounding region of the blob tracker between consecutive video frames divided by a global motion of the bounding region, the global motion including motion of the bounding region from a previous location in a previous video frame to a current location in the current video frame.

22. The method of claim 19, wherein determining the one or more characteristics of the blob tracker includes:
determining a bounding region magnitude ratio of the blob tracker, the bounding region magnitude ratio including a union of bounding regions of the blob tracker in at least two key frames divided by a union of bounding regions of the blob tracker in each frame between a previous video frame and the current video frame, wherein a key frame is aligned with a duration used for determining the status of the blob tracker.

23. The method claim 19, wherein determining the one or more characteristics of the blob tracker includes:
determining a temporal size change of the blob tracker, the temporal size change including a size of a bounding region of the blob tracker in the current video frame divided by a union of bounding regions of the blob tracker in each frame between a previous video frame and the current video frame, wherein the current video frame is aligned with a duration used for determining the status of the blob tracker.

24. An apparatus for maintaining blob trackers for one or more video frames of a video sequence, comprising:
a memory configured to store video data; and
a processor configured to:
identify a blob tracker for a current video frame of the video sequence, wherein the blob tracker is associated with a blob detected for the current video frame, the blob including pixels of at least a portion of one or more objects in the current video frame;
determine a confidence value for the blob tracker based on one or more characteristics of the blob tracker;
perform a false positive determination analysis on the blob tracker, wherein the false positive determination analysis is selected from a plurality of false positive determination processes based on the determined confidence value;
determine, based on the false positive determination analysis, a negative result for the blob tracker for the current video frame, the negative result indicating the blob tracker is not determined to be associated with a true positive object in the current video frame;
determine whether the current video frame is a key frame for the blob tracker in response to determining the negative result for the blob tracker for the current video frame, wherein a key frame occurs at a periodic key frame cycle; and
determine a status of the blob tracker based on whether the current video frame is a key frame for the blob tracker, the status of the blob tracker including a first type of blob tracker that is maintained for further analysis or a second type of blob tracker that is removed from a plurality of blob trackers maintained for the one or more video frames.

25. The apparatus of claim 24, wherein the processor is further configured to:
determine the blob tracker as the second type of blob tracker when the current video frame is determined to be a key frame for the blob tracker; and
remove the blob tracker from the plurality of blob trackers maintained for the one or more video frames.

26. The apparatus of claim 24, wherein the processor is further configured to determine the blob tracker is the first type of blob tracker when the current video frame is determined not to be a key frame for the blob tracker.

27. The apparatus claim 24, wherein the processor is further configured to:
determine a history duration of the blob tracker for a subsequent video frame occurring after the current video frame in the video sequence, the history duration indicating a number of video frames since creation of the blob tracker;
determine, for the subsequent video frame, whether the history duration of the blob tracker is less than a short-term cycle threshold, the short-term cycle threshold including one or more periodic key frame cycles; and
determine whether the blob tracker is a first type of false positive tracker or a second type of false positive tracker when the history duration of the blob tracker is less than the short-term cycle threshold, wherein the first type of false positive tracker has a first bounding box and a second bounding box with an overlapping ratio greater than an alignment threshold for the first type of false positive tracker, and wherein the second type of false positive tracker has an irregular size change or an irregular motion change over a periodic key frame cycle.

28. The apparatus of claim 24, wherein the apparatus is a mobile device.

29. The apparatus of claim 24, further comprising a camera for capturing the one or more video frames.

30. The apparatus of claim 24, further comprising a display for displaying the one or more video frames.
